(19) United States
(12) Patent Application Publication
(10) Pub. No.: US 2026/0322455 A1
(43) Pub. Date: Oct. 15, 2026

(54) Codebook Subset Restriction for Channel State Information (CSI) Feedback in Spatial-Frequency Domain

(71) Applicant: Telefonaktiebolaget LM Ericsson (publ), Stockholm (SE)

(72) Inventors: Chandan Pradhan, Kanagawa (JP); Mattias Frenne, Uppsala (SE); Ilmiawan Shubhi, Malmö (SE)

(21) Appl. No.: 19/485,038

(22) PCT Filed: Jun. 20, 2024
(86) PCT No.: PCT/SE2024/050616

§ 371 Date: Nov. 17, 2025

Related U.S. Application Data
(60) Provisional application No. 63/519,172, filed on Aug. 11, 2023.

(51) Int. Cl. H04B 7/06; H04L 41/16

(52) U.S. Cl. CPC H04B 7/0626; H04B 7/0639; H04L 41/16

(57) ABSTRACT

Embodiments include methods for a user equipment (UE) configured to provide channel state information (CSI) reports for a downlink (DE) channel from a radio access network (RAN) node. Such methods include receiving, from the RAN node, codebook subset restriction (CBSR) information that restricts reporting of vectors representative of the DE channel in a spatial-frequency domain. Such methods include determining a plurality of vectors and a corresponding plurality of scalar values representative of the DE channel in the spatial-frequency domain, and determining one or more of the following information based on the CBSR information: a subset of the vectors, a plurality of further vectors derived from the vectors, and measures of vector similarity between the vectors and the CBSR information. Such methods include sending to the RAN node a CSI report including at least part of the determined information. The included information is encoded using a machine learning (ML) model.

### TECHNICAL FIELD

The present disclosure relates generally to wireless networks, and more specifically to techniques for training network-based decoders of user equipment (UE)-encoded feedback about a downlink (DL) channel from the network to the UE, such as when the network decoder and UE encoder use artificial intelligence (AI) and/or machine learning (ML) techniques.

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases.

5G/NR technology shares many similarities with fourth generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a DL (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

5G/NR networks are expected to operate at higher frequencies such as 5-60 GHz, which are typically referred to as “millimeter wave” or “mmW” for short. Such systems are also expected to utilize a variety of multi-antenna technology (e.g., antenna arrays) at the transmitter, the receiver, or both. In general, multi-antenna technology can include a plurality of antennas in combination with advanced signal processing techniques (e.g., beamforming). Multi-antenna technology can be used to improve various aspects of a communication system, including system capacity (e.g., more users per unit bandwidth per unit area), coverage (e.g., larger area for given bandwidth and number of users), and increased per-user data rate (e.g., in a given bandwidth and area).

Availability of multiple antennas at the transmitter and/or the receiver can be utilized in different ways to achieve different goals. For example, multiple antennas at the transmitter and/or the receiver can be used to provide additional diversity against radio channel fading. To achieve such diversity, the channels experienced by the different antennas should have low mutual correlation, e.g., a sufficiently large antenna spacing (“spatial diversity”) and/or different polarization directions (“polarization diversity”).

As another example, multiple antennas at the transmitter and/or the receiver can be used to shape or “form” the overall antenna beam (e.g., transmit and/or receive beam, respectively) in a certain way, with the general goal being to improve the received signal-to-interference-plus-noise ratio (SINR) and, ultimately, system capacity and/or coverage. This can be done, for example, by maximizing the overall antenna gain in the direction of the target receiver or transmitter or by suppressing specific dominant interfering signals.

In relatively good channel conditions, the capacity of the channel becomes saturated such that further improving the SINR provides limited capacity improvements. In such cases, using multiple antennas at both the transmitter and the receiver can be used to create multiple parallel communication “channels” over the radio interface. This can facilitate a highly efficient utilization of both the available transmit power and the available bandwidth resulting in, e.g., very high data rates within a limited bandwidth without a disproportionate degradation in coverage. For example, under certain conditions, the channel capacity can increase linearly with the number of antennas and avoid saturation in the data capacity and/or rates. These techniques are commonly referred to as “spatial multiplexing” or multiple-input, multiple-output (MIMO) antenna processing.

Accordingly, spatial multiplexing is a key feature to increase the spectral efficiency of a wireless systems, including 5G/NR. Transmitting multiple layers on the same time-frequency resource can increase the data-rate for a single user (referred to as “SU-MIMO”). Alternatively, transmitting multiple layers on the same time-frequency resource to multiple users (referred to as “MU-MIMO”) can increase the system capacity in terms of number of users.

More specifically, a multi-antenna base station with N_{TX} antenna ports simultaneously transmits information to several UEs using the same OFDM time-frequency resources. Before modulation and transmission, a precoding matrix

$${W}_{V}^{( j )}$$

is applied to sequence S⁽ⁱ⁾ transmitted to user (or UE) i for spatial separation from other transmissions and mitigation of multiplexing interference. Each UE(i) demodulates its received signal and combines receiver antenna signals to obtain an estimate Ŝ⁽ⁱ⁾ of sequence S⁽ⁱ⁾ transmitted to it. In general, the precoder

$${W}_{V}^{( i )}$$

used for the transmission to UE(i) should correlate well with DL channel H⁽ⁱ⁾ observed by UE(i) but correlate poorly with DL channels observed by other UEs.

To construct precoders that enable efficient MU-MIMO transmissions, the base station needs to acquire detailed knowledge of the DL channels H(i). In deployments where channel reciprocity holds, detailed channel knowledge can be acquired from UL sounding reference signals (SRS) that are transmitted periodically, or on demand, by active UEs. Based on these SRS, the base station can directly estimate the UL channel and, therefore, the DL channel H⁽ⁱ⁾.

However, the base station cannot always accurately estimate the DL channel from UL SRS. In such cases, active UEs need to report DL channel information to the base station. In LTE and NR, a base station periodically transmits DL CSI-RS from which the UE estimates the DL channel. The UE reports CSI feedback to the base station over an UL channel, e.g., physical UL control channel (PUCCH) or physical UL shared channel (PUSCH). The UE selects the CSI feedback from a codebook that is configured by the base station based on the estimated DL channel. The base station uses the UE's CSI feedback to select suitable precoders for DL MU-MIMO transmissions. The CSI feedback mechanism from the UE to the base station or network targeting MU-MIMO operations in NR is referred to as CSI Type II reporting.

Recently neural network based autoencoders (AEs) have shown promising results for compressing DL channel estimates for UL CSI feedback by the UE. An AE is a type of artificial neural network (NN) that can be used to compress data in an unsupervised manner. These networks are trained to compress and reconstruct data (e.g., channel estimates) with high fidelity, using a two-sided artificial intelligence/machine learning (AI/ML) model. For various reasons, AE-based CSI feedback is of interest for 3GPP Rel-18 and beyond.

### SUMMARY

Conventionally, the base station may configure the UE with a codebook subset restriction (CBSR) that prevents a UE from selecting certain codebook entries for CSI feedback in a CSI report. This reduces complexity for the UE to construct a CSI report and is a way to efficiently manage payload of UL control information (UCI) such as CSI feedback. While a conventional CSI report is based on channel information in beam or beam-delay domains, an AE-based CSI report can include channel information in the form of raw eigenvectors in spatial-frequency domain. Currently, however, there are no comparable CBSR techniques for codebooks in the spatial-frequency domain. This can cause various problems, issues, and/or difficulties with AE-based CSI feedback.

For example, in conventional Rel-16 Type II CSI feedback, a UE uses a Discrete Fourier Transform (DFT) to transform the channel to a beam-delay domain used to obtain the Rel-16 Type II CSI feedback to its serving radio access network (RAN) node. In particular, the UE reports indices of DFT beams it used to construct a precoder, which the RAN node then uses to reconstruct the precoder. In conventional techniques, the RAN node indicates CBSR in terms of DFT beam indices along specific direction(s) and/or amplitude scaling per DFT beam. When the UE receives the CBSR, it refrains from using these restricted DFT beam indices and/or applying the restricted amplitude scaling to the beams while constructing the precoder. However, when the CSI feedback for the precoder is in the form of eigenvectors in the spatial-frequency domain, the precoders are not determined (at least directly) based on DFT beams and conventional CBSR becomes inapplicable.

An object of embodiments of the present disclosure is to provide CBSR-type solutions for CSI codebooks in the spatial-frequency domain, thereby facilitating efficient reporting of AE-based CSI feedback in a wireless network.

Embodiments include methods (e.g., procedures) for a UE configured to provide CSI reports for a DL channel from a RAN node serving the UE.

These exemplary methods include receiving, from the RAN node, codebook subset restriction (CBSR) information that restricts reporting of vectors representative of the DL channel in a spatial-frequency domain. These exemplary methods also include determining a plurality of vectors and a corresponding plurality of scalar values representative of the DL channel in the spatial-frequency domain. These exemplary methods also include determining one or more of the following based on the CBSR information: a subset of the plurality of vectors, a plurality of further vectors derived from the plurality of vectors, and one or more measures of vector similarity between the plurality of vectors and the CBSR information. These exemplary methods also include sending to the RAN node a CSI report including at least part of the determined information, wherein the included information is encoded using an ML model.

Other embodiments include methods (e.g., procedures) for a RAN node configured to receive CSI reports from a UE for a DL channel to the UE. These exemplary methods are generally complementary to the exemplary UE methods summarized above.

These exemplary methods include sending, to the UE, CBSR information that restricts reporting of eigenvectors representative of the DL channel in a spatial-frequency domain. These exemplary methods also include receiving from the UE a CSI report including one of the following information that is based on the CBSR information and that is encoded based on an ML model:
a subset of a plurality of vectors that are representative of the DL channel in the spatial-frequency domain;
a plurality of further vectors derived from the plurality of vectors; or
one or more measures of vector similarity between the plurality of vectors and the CBSR information.
   These exemplary methods also includes decoding the encoded information using an ML model corresponding to the ML model used to encode the information.

In some of the various embodiments summarized above, the DL channel is a multiple input multiple output (MIMO) channel and the CBSR information defines a restricted subspace of the MIMO channel. In some embodiments, the plurality of vectors representative of the DL channel in the spatial-frequency domain are eigenvectors, and the corresponding plurality of scalar values are eigenvalues. In some embodiments, the vector similarity (i.e., based on which the one or more measures are determined) is one of the following: generalized cosine similarity (GCS), squared generalized cosine similarity (SCGS), Euclidean cosine similarity (ECS), squared Euclidean cosine similarity (SECS), or normalized mean square error (NMSE).

In some embodiments, the CBSR information includes one or more of the following:
an indication of one or more restricted entries of a first codebook of vectors representing respective spatial beam directions;
an indication of one or more restricted entries of a second codebook of vectors in the spatial-frequency domain;
a threshold for the measure of vector similarity;
a number of the vectors to be selected based on largest corresponding scalar values; and
an identifier of the ML model, which is capable of encoding the number of vectors.
an identifier of the ML model, which is capable of encoding the number of eigenvectors.

In some of these embodiments, the plurality of vectors are associated with respective different combinations of the following: one of a plurality of frequency subbands of the DL channel, and one of a plurality of transmission ranks, rᵢ=1 to r, where r is a maximum allowed transmission rank. In other words, each vector is associated with a different subband-rank combination than other vectors.

In some of these embodiments, the measure of vector similarity is of similarity between the following: the restricted entries in the first codebook, and the vectors associated with the plurality of frequency subbands and with a particular transmission rank rᵢ. In some variants, the received encoded information includes the plurality of vectors and respective measures of vector similarity for the vectors associated with the respective plurality of transmission ranks, rᵢ=1 to r.

In other variants, the subset of the plurality of eigenvectors includes the vectors associated with rᵢ, when the measure of vector similarity for the vectors associated with rᵢ is less than the threshold. Likewise, the subset of the plurality of eigenvectors excludes the vectors associated with rᵢ, when the measure of vector similarity for the vectors associated with rᵢ is greater than or equal to the threshold.

In other of these embodiments, each further vector is based on removal of projections of a corresponding one of the plurality of vectors onto the restricted entries of the first codebook, such that the further vector is uncorrelated with the corresponding vector.

Other embodiments include UEs (e.g., wireless devices, IoT devices, etc., or components thereof) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments can facilitate efficient AI-based CSI feedback in the spatial-frequency domain. For example, a RAN node can control interference in certain spatial (beam) directions by restricting a UE from selecting a precoding matrix indicator (PMI) corresponding to these directions (e.g., toward UEs of a neighboring cell). By use of CBSR in spatial-frequency domain, embodiments also facilitate reduced complexity for the UE to construct a CSI report and efficiently manage UCI payload for CSI reporting. Due to these advantages, embodiments can improve the overall performance of MU-MIMO used to transmit DL data to multiple UEs concurrently.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary 5G/NR network architecture.

FIG. 2 shows exemplary NR UP and CP protocol stacks.

FIG. 3 shows a block diagram of an exemplary MU-MIMO arrangement.

FIG. 4 shows beams of a 32-vector DFT beamforming codebook covering an orientation range of +/−90 degrees.

FIGS. 5-6 illustrates various aspects of Type II CSI feedback.

FIG. 7 illustrates a fully connected autoencoder (AE) architecture.

FIG. 8 illustrates an exemplary application of AEs to CSI reporting by UEs.

FIG. 9 illustrates quantization aspects of AEs used for CSI reporting by UEs.

FIG. 10 shows a high-level view of exemplary lifecycle management (LCM) for an AI or ML models.

FIG. 11 shows a functional framework that can be used for studying different RAN-UE collaboration levels for the use of AI models in physical layer (PHY) use cases.

FIGS. 12-13 show cumulative density functions (CDFs) for generalized cosine similarity (GCS) between beams restricted by CBSR and eigenvectors obtained from a UE channel estimate, according to various embodiments of the present disclosure.

FIGS. 14-15 show various exemplary ASN.1 data structures according to various embodiments of the present disclosure.

FIG. 16 shows a flow diagram of an exemplary method for UE (e.g., wireless device, etc.) of a wireless network, according to various embodiments of the present disclosure.

FIG. 17 shows a flow diagram of an exemplary method for a RAN node (e.g., base station, eNB, gNB, ng-eNB, etc.), according to various embodiments of the present disclosure.

FIG. 18 shows a communication system according to various embodiments of the present disclosure.

FIG. 19 shows a UE according to various embodiments of the present disclosure.

FIG. 20 shows a network node according to various embodiments of the present disclosure.

FIG. 21 is a block diagram of a virtualization environment in which functions implemented by some embodiments of the present disclosure may be virtualized.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

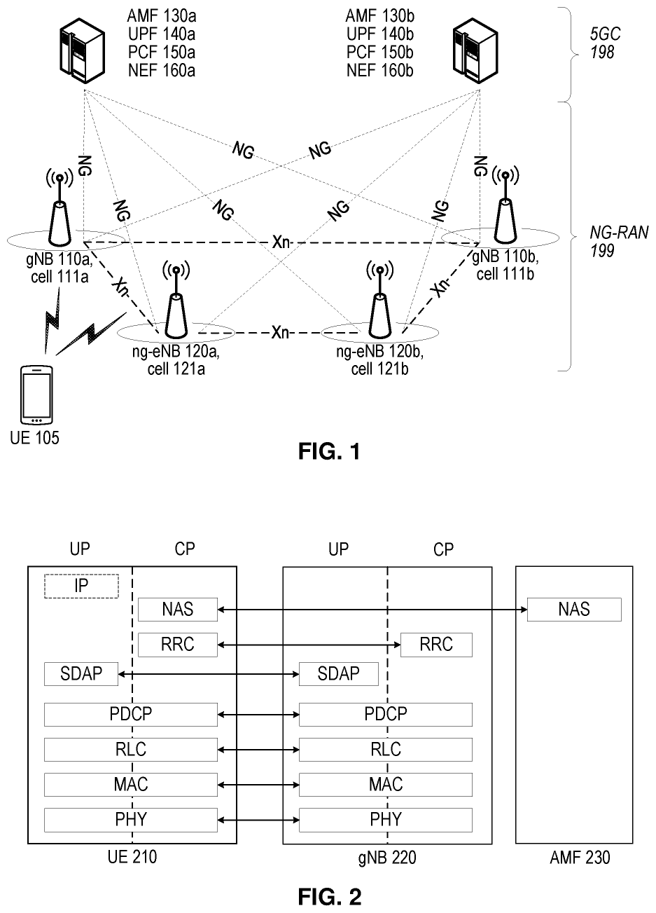

FIG. 1 illustrates an exemplary high-level view of the 5G network architecture, consisting of a Next Generation RAN (NG-RAN, 199) and a 5G Core (5GC, 198). As shown in the figure, the NG-RAN can include gNBs (e.g., 110a,b) and ng-eNBs (e.g., 120a,b) that are interconnected with each other via respective Xn interfaces. The gNBs and ng-eNBs are also connected via the NG interfaces to the 5GC, more specifically to Access and Mobility Management Functions (AMFs, e.g., 130a,b) via respective NG-C interfaces and to User Plane Functions (UPFs, e.g., 140a,b) via respective NG-U interfaces. Moreover, the AMFs can communicate with one or more policy control functions (PCFs, e.g., 150a,b) and network exposure functions (NEFs, e.g., 160a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 111a-b, 121a-b). Depending on the cell in which it is located, a UE (105) can communicate with the gNB or ng-eNB serving that cell via the NR or LTE radio interface, respectively. Although FIG. 1 shows gNBs and ng-eNBs separately, it is also possible that a single NG-RAN node provides both types of functionality.

Each of the gNBs may include and/or be associated with a plurality of Transmission Reception Points (TRPs). Each TRP typically includes an antenna array with one or more antenna elements and is located at a specific geographical location. In this manner, a gNB associated with multiple TRPs can transmit the same or different signals from each of the TRPs. For example, multiple TRPs can transmit different versions of a signal to a single UE. Each TRP can use beams for transmission/reception with UEs served by the gNB, as discussed below.

FIG. 2 shows an exemplary configuration of NR user plane (UP) and control plane (CP) protocol stacks between a UE (210), a gNB (220), and an AMF (230), such as those shown in FIG. 1. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and manages transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB.

An NR UE in RRC_IDLE state is not known to the gNB serving the cell where the UE is camping. The UE must perform a random-access (RA) procedure to move from RRC_IDLE to RRC_CONNECTED state, where the cell serving the UE is known and an RRC context is established for the UE in the serving gNB, such that the UE and gNB can communicate. As part of (or in conjunction with) the RA procedure, the UE also transmits an RRCSetupRequest message to the serving gNB. NR RRC also includes an RRC_INACTIVE state in which a UE is known (e.g., via UE context) by the serving gNB. RRC_INACTIVE has some properties similar to a “suspended” condition used in LTE.

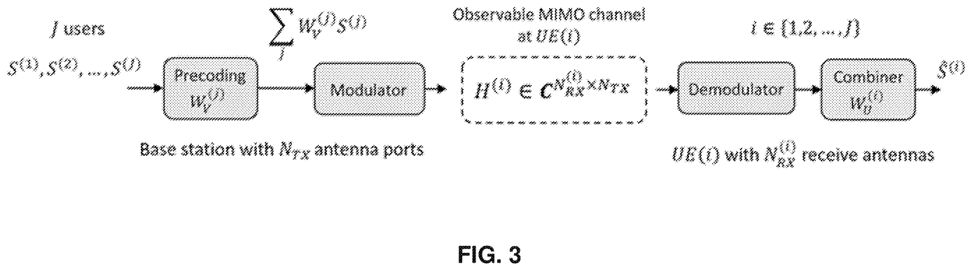

FIG. 3 shows a block diagram of an exemplary MU-MIMO transmission arrangement. A multi-antenna base station with N_{TX} antenna ports simultaneously transmits information to several UEs using the same OFDM time-frequency resources. For example, sequence S⁽¹⁾ is transmitted to UE(1), S⁽²⁾ is transmitted to UE(2), and so on. Before modulation and transmission, a precoding matrix

$${W}_{V}^{( j )}$$

is applied to sequence S⁽ⁱ⁾ transmitted to user (or UE) i for spatial separation from other transmissions and mitigation of multiplexing interference.

Each UE(i) demodulates its received signal and combines receiver antenna signals in order to obtain an estimate Ŝ⁽ⁱ⁾ of sequence S⁽ⁱ⁾ transmitted to it. Note the order of modulation and precoding, or demodulation and combining respectively, may differ from FIG. 1 depending on the specific implementation of MU-MIMO transmission. In general, the precoder

$${W}_{V}^{( i )}$$

should correlate well with channel H⁽ⁱ⁾ observed by UE(i) and it should correlate poorly with the channels observed by other UEs. This estimate Ŝ⁽ⁱ⁾ can be expressed as:

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference seen by UE(i). The goal for the base station is to construct the set of precoders

$$\{ {W}_{V}^{( j )} \}$$

to meet one or more targets, such as to make:
the norm

$$‖ {H}^{( i )} {W}_{V}^{( i )} ‖$$

large, since this norm represents the desired channel gain towards user i); and
the norm

$$‖ {H}^{( j )} {W}_{V}^{( i )} ‖ ,$$

j≠i small, since this norm represents the interference of user i's transmission received by user j.
In other words, the precoder

$${W}_{V}^{( i )}$$

should correlate well with the channel H⁽ⁱ⁾ observed by UE(i) while correlating poorly with the channels observed by other UEs.

To construct precoders that enable efficient MU-MIMO transmissions, the base station needs to acquire detailed knowledge of the DL channels H(i). In deployments where reciprocity exists between UL and DL channels, detailed channel knowledge can be acquired from UL SRS that are transmitted periodically, or on demand, by active UEs. Based on these SRS, the base station can directly estimate the UL channel and, therefore, the DL channel H⁽ⁱ⁾ by reciprocity.

However, the base station cannot always accurately estimate the DL channel from UL reference signals. For example, in frequency division duplex (FDD) deployments, the UL and DL channels use different carriers and, therefore, the UL channel might not provide enough information about the DL channel to enable MU-MIMO precoding. Additionally, the base station may only be able to estimate part of the UL channel. For example, the UE has fewer TX branches than RX branches, in which case only certain columns of the precoding matrix can be estimated using UL SRS.

If the base station cannot estimate the DL channel from UL transmissions, then active UEs need to feedback channel information to the base station. In LTE and NR, a base station periodically transmits DL CSI-RS from which the UE estimates the DL channel. The UE reports CSI feedback to the base station over an UL channel, e.g., physical UL control channel (PUCCH) or physical UL shared channel (PUSCH). The base station uses the UE's feedback to select suitable precoders for DL MU-MIMO transmissions.

In general, CSI feedback mechanisms for NR are based on codebooks stored in the UE and configured by the serving RAN node. For example, a Type I codebook is used for SU-MIMO while various types of Type II codebooks are configurable for MU-MIMO, including the following:
Type II codebook (Rel-15)
Type II Port Selection codebook (Rel-15)
Enhanced Type II codebook (Rel-16)
Enhanced Type II Port Selection codebook (Rel-16)
Further enhanced Type II Port Selection codebook (Rel-17)
   In general, the following parameters are configured for Type II codebooks:
Subtype;
Number of beams (Rel-15);
Number of bits for quantizing each reported coefficient;
Parameter combination (Rel-16/Rel-17);
Number of precoding matrix indicator (PMI) subbands per channel quality indicator (CQI) subband;
Codebook subset restriction (CBSR); and
Rank restriction.

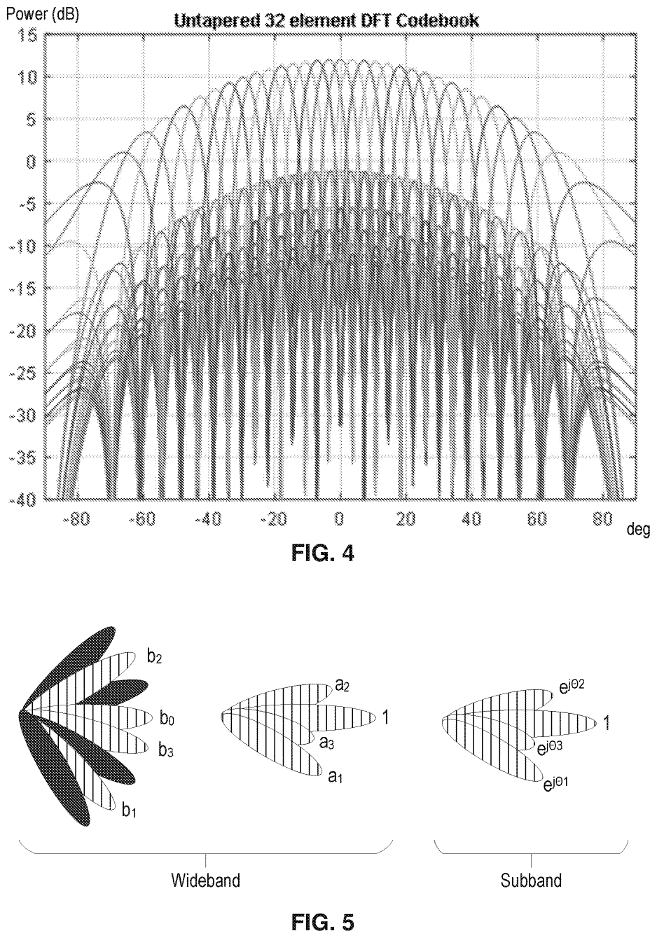

Normal Type II CSI reporting is based on the specification of sets of DFT basis functions (also referred to as “grid of beams”) in a precoder codebook. In general, the DFT basis functions (or vectors) provide a set of beams equally spaced in orientation over a range of interest. This arrangement provides the narrowest beam and also full utilization of power amplifiers (PAs), but at the expense of high sidelobes. FIG. 4 illustrates a grid of beams for a 32-element DFT codebook covering an azimuth range of +/−90 degrees, where the maximum sidelobe for each beam is 13 dB below the peak for that beam.

The UE selects and reports the L DFT vectors from the codebook that best match DL channel conditions. This approach is similar to PMI from earlier 3GPP releases. The number L is configurable to be 2 or 4 for Rel-15, and 2, 4, or 6 for Rel-16. The UE also reports how the L DFT vectors should be combined in terms of relative amplitude scaling and co-phasing. In general, each DFT vector corresponds to a beam, particularly when the base station has a uniform planar array with antenna elements separated by less than half of the carrier wavelength. Based on this technical context, the terms “DFT vector” and “beam” are used synonymously herein unless expressly stated otherwise or a different meaning is clear from a particular context of use.

FIG. 5 illustrates CSI type II feedback mode, which is further described in 3GPP TS 38.214 (v17.6.0). The selection and reporting of the L DFT beam vectors bₙ and their relative amplitudes aₙ is done in a wideband manner, i.e., the same beams are used for both polarizations over the whole band. However, the selection and reporting of the beam co-phasing coefficients is done in a sub-band manner, i.e., co-phasing parameters are determined for each of multiple subsets of contiguous subcarriers. The co-phasing parameters are quantized such that e^{jθ}^{ₙ} is taken from either a QPSK or 8PSK signal constellation. With k denoting a sub-band index, the precoder reported by the UE can be expressed as:

$${W}_{V} [ k ] = {\sum }_{n} {b}_{n} {a}_{n} {e}^{j {θ}_{n} [ k ]} .$$

The Type II CSI report can be used by the base station to spatially co-schedule multiple UEs on the same OFDM time-frequency resources. For example, the base station can select UEs that have reported different sets of beams or beams that have weak correlations. The CSI Type II report enables the UE to report a precoder hypothesis that trades CSI resolution for reduced UL transmission overhead.

NR Rel-15 also supports Type II CSI feedback using port selection. In this case, the base station transmits a CSI-RS port in each of the beam directions, but the UE does not use a codebook to select a DFT vector (or beam). Instead, the UE selects one or multiple antenna ports from the CSI-RS resource of multiple ports. Type II CSI feedback using port selection gives the base station some flexibility to use non-standardized precoders, which are transparent to the UE. For the port-selection codebook, the precoder reported by the UE can be described as:

$${W}_{V} [ k ] = {\sum }_{n} {e}_{n} {a}_{n} {e}^{j {θ}_{n} [ k ]} .$$

where e is a unit vector with only one non-zero element. In effect, e is a “selection vector” that selects a port from the set of ports in the measured CSI-RS resource. The UE thus feeds back which ports it has selected, the amplitude factors, and the co-phasing factors.

In Rel-16 Type II, the CSI report can be further compressed in the frequency domain (FD), where a set of FD DFT basis vectors are selected by the UE. The number of selected FD basis vectors is a function of the number of CQI subbands, the number of PMI subbands per CQI subband and a ratio that determines the FD compression (termed as pᵥ in 3GPP TS 38.214, where v is the layer index). These are configured by the UE's serving RAN node via RRC signaling. In addition, the UE also reports non-zero coefficients (NZCs) associated with the selected beams for Rel-15 Type II, which informs the gNB how these beams should be combined in terms of relative amplitude scaling and co-phasing for each subband. In Rel-16, the reported NZCs are then associated with selected beams and FD basis vectors.

In Rel-16, to further compress the CSI report, the RAN node also configures a ratio (B) that determines the maximum number of NZCs to be reported. For example, for a single layer transmission where 2 L beams and M FD basis vectors are configured by gNB, there are in total 2 LM linear combination coefficients. However, a maximum of [2LMβ] NZCs will be reported, with the remaining 2 LM-┌2LMβ┐ are treated as zeros and are not reported. The selected beams are commonly used for all subbands and all transmission layers, whereas the NZCs (for both Rel-15 and Rel-16 Type II) and FD basis vectors (for Rel-16 Type II) are layer-specific.

In NR, a UE can be configured with one or multiple CSI Report Settings, each configured by a higher layer parameter CSI-ReportConfig. Each CSI-ReportConfig is associated with a bandwidth part (BWP) and contains one or more of the following:
a CSI resource configuration for channel measurement;
a CSI-IM resource configuration for interference measurement;
reporting configuration type, i.e., aperiodic CSI (on PUSCH), periodic CSI (on PUCCH), or semi-persistent CSI on PUCCH or PUSCH;
report quantity specifying what to be reported, such as RI, PMI, CQI;
codebook configuration such as type I or type II CSI;
frequency domain configuration, i.e., subband vs. wideband CQI or PMI, subband size;
CQI table to be used.

A UE can be configured with one or multiple CSI resource configurations for channel measurement and one or more CSI-IM resources for interference measurement. Each CSI resource configuration for channel measurement can contain one or more non-zero power (NZP) CSI-RS resource sets. For each NZP CSI-RS resource set, it can further contain one or more NZP CSI-RS resources. A NZP CSI-RS resource can be periodic, semi-persistent, or aperiodic. Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

A UE performs aperiodic CSI reporting using PUSCH upon successful decoding of a downlink control information (DCI) format 0_1 or format 0_2 message on physical DL shared channel (PDSCH), which triggers an aperiodic CSI trigger state. When a DCI format 0_1 message schedules two PUSCH allocations, the aperiodic CSI report is carried on the second scheduled PUSCH. When a DCI format 0_1 message schedules more than two PUSCH allocations, the aperiodic CSI report is carried on the penultimate scheduled PUSCH. In contrast, a UE performs semi-persistent CSI reporting using PUSCH upon successful decoding of a DCI format 0_1 or format 0_2 message that activates a semi-persistent CSI trigger state. DCI formats 0_1 and 0_2 contain a CSI request field that indicates the semi-persistent CSI trigger state to activate or deactivate. The PUSCH resources and modulation and coding scheme (MCS) are allocated semi-persistently by DCI. In both aperiodic and semi-persistent cases, CSI reporting on PUSCH can be multiplexed with UL data on PUSCH, but can also be performed without any multiplexing with UL data.

For the Rel-15 and Rel-16 Type II CSI feedback on PUSCH, a CSI report includes parts 1 and 2. A main motivation for dividing a CSI report into these parts is to deal with the dynamically varying CSI payload. For example, based on the time-varying channel, UE may report different ranks at different times over the duration of a connection, which causes the required CSI payload size to vary. Accordingly, Part 1 has a fixed payload size that includes information needed to calculate the payload size of Part 2, and will be decoded first by the RAN node.

For Rel-15 Type II CSI feedback, part 1 contains rank indicator (RI, if reported), CQI, and an indication of the number of non-zero wideband amplitude coefficients per layer (see 3GPP TS 38.214 v17.6.0 clause 5.2.2.2.3). The fields of Part 1 are individually encoded. Part 2 contains the PMI of the Type II CSI. Part 1 and 2 are separately encoded.

For Rel-16 Type II CSI feedback, part 1 contains RI, CQI, and an indication of the overall number of non-zero amplitude coefficients across layers (see 3GPP TS 38.214 v17.6.0 clause 5.2.2.2.5). The fields of Part 1 are individually encoded. Part 2 contains the PMI of the Enhanced Type II CSI. Part 1 and 2 are separately encoded.

When configured for CSI feedback, a codebook subset restriction (CBSR) prevents a UE from selecting certain codebook entries (e.g., PMI) for CSI feedback. For example, CBSR can be used to control interference in certain spatial (beam) directions by restricting a UE from selecting a PMI corresponding to these directions (e.g., toward UEs of a neighboring cell). CBSR also reduces complexity for the UE to construct a CSI report and is a way to efficiently manage payload of UL control information (UCI). Even so, as codebooks have gotten more complicated, the indication of CBSR has consumed more DL signaling overhead and various schemes have been devised to reduce signaling load related to CBSR.

To reduce CBSR signaling overhead, LTE FD-MIMO and NR Type I CSI feedback use beam-based rank-agnostic CBSR signaling as opposed to PMI-based per-rank CBSR that was used in earlier LTE releases. In PMI-based per-rank CBSR, precoders are restricted by signaling one or more bitmaps for each rank (e.g., 8 sets of bitmaps for ranks 1-8). Each bit in a bitmap restricts one PMI index (e.g., i1 or i2) for the codebook associated with the corresponding rank.

In beam-based rank-agnostic CBSR, the constituent 2D DFT beams v_{l,m} are instead restricted, resulting in a size N₁N₂O₁O₂ bitmap in which each bit restricts a certain (l₀, m₀) index pair corresponding to a beam vₗ_{₀}_{,m}_{₀}. Since the quantity vim are the constructing blocks for precoders of all ranks, a substantial overhead reduction in CBSR signaling is attained. A precoder in the codebook is restricted if any of the restricted beams vim are present in the precoder.

While Type I CBSR uses beam restriction directly as discussed above, both Rel-15 and Rel-16 NR Type II CBSR essentially uses joint beam and beam amplitude restriction, where the restricted beams can have soft amplitude thresholds {0, \sqrt{0.25}, \sqrt{0.5}, 1}. The restricted beams for both Rel-15 and Rel-16 Type II codebooks are configured in the same way.

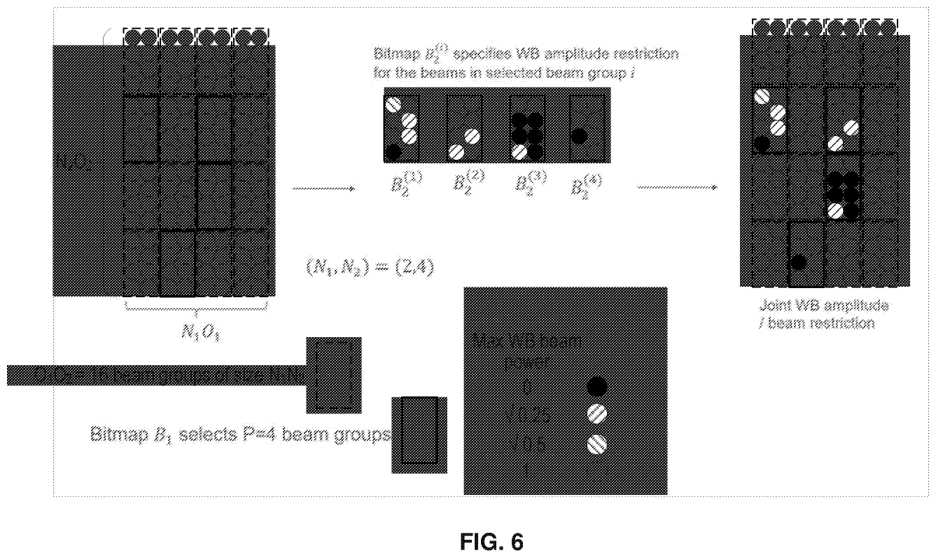

FIG. 6 shows an example of Type II CBSR, where four (4) out of O₁O₂=16 beam groups have amplitude restriction, with each group containing N₁N₂=8 orthogonal DFT beams. In other words, a subset of 4N₁N₂ beams have amplitude restriction, while the remaining N₁N₂O₁O₂−4N₁N₂ beams have no such restriction. For each beam in this subset, a maximum amplitude value is configured, such that the beam will be excluded from the PMI if its corresponding amplitude exceeds this maximum amplitude.

However, the beam amplitude calculation differs between Rel-15 and Rel-16 Type II CBSR. In Rel-15, the amplitude for a beam is represented by the corresponding wideband amplitude coefficient

$${p}_{l , i}^{( 1 )} .$$

In Rel-16, however, a FD parametrized codebook structure is used, with the amplitude for a beam calculated by normalizing the squared sum of all the coefficients for all associated FD basis vectors with this beam according to the following equation:

$$\sqrt{\frac{1}{{\sum }_{f = 0}^{{M}_{υ} - 1} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + p L}$$

where l∈{1, . . . , v}, i∈{0, . . . , L−1}, p∈{0, 1}, and γ_{i+pL}∈{0, \sqrt{0.25}, \sqrt{0.5}, 1} is the maximum average coefficient amplitude. The beam-specific maximum amplitude value, for both Rel-15 and Rel-16 Type II, applies for both polarizations as well as for all layers. Detailed definition of the parameters in the above inequality can be found in 3GPP TS 38.214 (v17.6.0) clause 5.2.2.2.5.

Recently, neural network based autoencoders (AEs) have shown promising results for compressing DL MIMO channel estimates for CSI feedback by the UE. An AE is a type of artificial neural network (NN) that can be used to compress data in an unsupervised manner. These networks are trained to compress and reconstruct data (e.g., channel estimates) with high fidelity. 3GPP has also initiated a Rel-18 study item for AE-based CSI reporting in which AEs will play a central part.

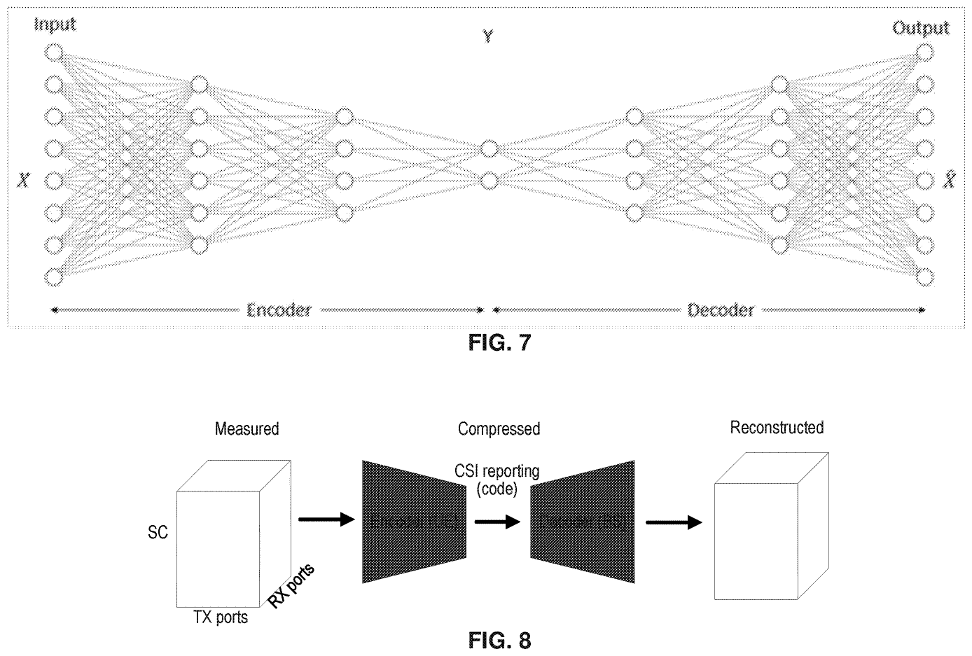

FIG. 7 illustrates a simple fully connected (dense) AE architecture. This exemplary AE is divided into two parts: an encoder (located in the UE), and a decoder (located in the network, e.g., base station). The output of the encoder (so-called “bottleneck layer” of the AE) represents the codeword that is to be signaled from the UE to the network over the UL. The codeword can be viewed as a sequence of latent variables, which describe the latent representation of the channel.

In addition to the fully connected (dense) architecture show in FIG. 4, AEs can be based on other fully-connected NNs, multi-dimensional convolution NNs, recurrent NNs, or any combination thereof. However, all AEs architectures possess the encoder-bottleneck-decoder structure illustrated in FIG. 7. The size of the codeword (Y in FIG. 7) of an AE is typically a lot smaller than the size of the input data (X in FIG. 7). The AE encoder reduces the dimensionality of the input features with increasing depth of the neural network. The AE decoder essentially tries to invert the encoder and reconstruct the original input data with minimal error (according to some predefined loss function).

The architecture of an AE typically needs to be numerically optimized for the specific application (e.g., channel estimate compression) via a process called hyperparameter tuning. Properties of the data (e.g., CSI-RS measurements), the channel size, uplink feedback rate, and hardware limitations of the encoder and decoder all need to be considered when optimizing the AE's architecture.

The weights and biases of an AE (with a fixed architecture) are trained to minimize the reconstruction error (the error between the input X and output X) on some training dataset. For example, the weights and biases can be trained to minimize the mean squared error (MSE) (X−\hat{X})². Model training is typically done using some variant of the gradient descent algorithm on a large data set. The training data set should be representative of the actual data the AE will encounter during live operation. The process of designing an AE (hyperparameter tuning and model training) consumes significant time, compute, memory, and power resources.

AEs can also be trained to exploit long-term redundancies in the propagation environment and/or site (e.g., antenna configuration) for compression purposes. For example, a particular AE does not need to work well for all possible deployments. Improved compression performance is obtained by learning which channel inputs it needs to (and doesn't need to) reliably reconstruct at the base-station.

AEs can also be trained to compensate for antenna array irregularities, such as non-uniformly and/or non-half wavelength element spacing. In contrast, the Type II CSI codebooks in Rel-15 and Rel-16 use a two-dimensional DFT codebook designed for a regular planar array with perfect half wavelength element spacing.

AEs can also be updated (e.g., via transfer learning and training) to compensate for failing hardware as the product ages. For example, over time Tx and Rx radio chains will fail compromising the effectiveness of Type II CSI feedback.

FIG. 8 illustrates an exemplary application of AEs to MIMO transmission. The UE measures the channel in the downlink using CSI-RS. The UE estimates that channel for each subcarrier (sc) from each base station TX antenna and at each UE RX antenna. The estimate can be viewed as a three-dimensional (3D) channel matrix or tensor. The 3D channel matrix representing the MIMO channel estimated over several subcarriers is input to the encoder.

For compression of UL CSI reports for the DL channel, the encoder is implemented in the UE and the decoder is implemented in the network (e.g., base station). It is also possible to reverse the CSI reporting operation, such that the base station measures the UL channel using UE transmitted SRS and reports uplink CSI to the UE using an AE encoder. The UL channel can then be reconstructed by the UE using the AE decoder.

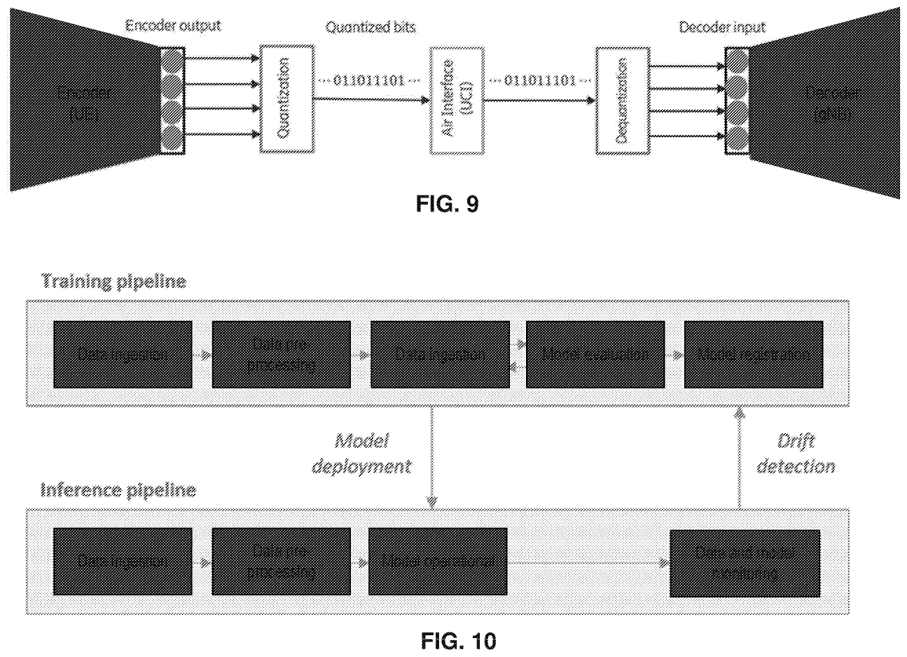

In the dual-sided CSI compression scheme, the output of the UE-side encoder needs to be sent over the air interface to the RAN node decoder together with the assigned CSI reporting payload. To do so, the encoder output needs to be quantized to a finite number of bits (e.g., 1-4 bits per sample) to obtain an efficient transmission. FIG. 9 shows an arrangement similar to FIG. 8 but including exemplary encoder-side quantization and decoder-side dequantization. In particular, a quantization layer is provided at the output of the encoder or directly included in the encoder. The quantization layer quantizes the output of each neuron of the encoder output layer (AE bottleneck layer) to generate bits to fit the CSI reporting payload in the UCI. In relation to the AI/ML model training, this quantization may be performed during inference but not during training (referred to as “quantization non-aware training”) or may be performed during inference and training (“quantization-aware training”).

FIG. 10 shows a high-level view of exemplary lifecycle management (LCM) for an AI or machine learning (ML) model, including training and inference pipelines and their interactions. The training pipeline include the following stages:
Data Ingestion: gathering raw (training) data from a data storage. After data ingestion, there may also be a step that controls the validity of the gathered data.
Data Pre-Processing: feature engineering applied to the gathered data, e.g., it may include data normalization and possibly a data transformation required for the input data to the AI model.
Model Training: actual model training steps.
Model Evaluation: benchmarking the performance to some model baseline. The iterative steps of model training and model evaluation continues until the acceptable level of performance (as previously exemplified) is achieved.
Model Registration: registering the AI model, including any corresponding AI-metadata that provides information on how the AI model was developed, and possibly AI model evaluations performance outcomes.

A deployment stage provides the trained (or re-trained) AI model to the inference pipeline, which includes the following stages:
Data Ingestion: gathering raw (inference) data from a data storage.
Data Pre-Processing: typically identical to corresponding processing that occurs in the training pipeline.
Model Operational: using the trained and deployed model in an operational mode.
Data and Model Monitoring: validating that the inference data are from a distribution that aligns well with the training data, as well as monitoring model outputs for detecting any performance, or operational, drifts.
   The LCM shown in FIG. 10 also includes a drift detection function that informs the training pipeline about any drifts detected during the model operations.

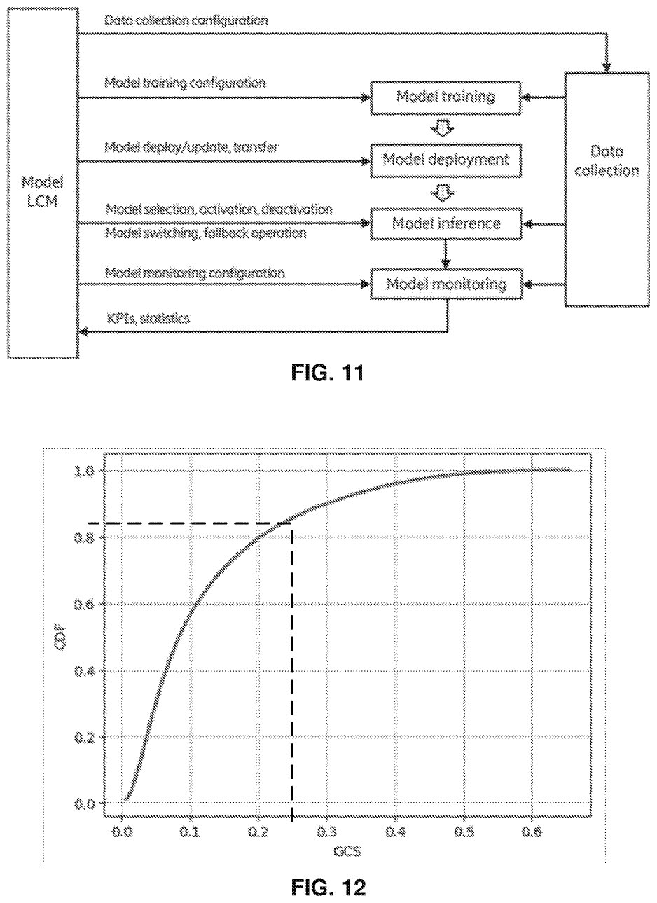

FIG. 11 shows a functional framework that can be used for studying different RAN-UE collaboration levels for the use of AI models in physical layer (PHY) use cases, such as CSI compression/encoding. This framework has many of the same features as the exemplary LCM shown in FIG. 10. Although model training, inference, and monitoring are shown separate from LCM in FIG. 11, this is merely for illustrative purposes and these functions can also be part of LCM as shown in FIG. 10.

The AI/ML models being discussed in the 3GPP Rel-18 study item on AI/ML for the NR air interface can be categorized one-sided or two-sided. One-side AI/ML models have inference performed entirely in the UE (UE-side model) or in the network (network-side model). In contrast, two-sided AI/ML models use joint inference performed at UE and in the network. For example, the first part of the inference is performed by UE and then the remaining part is performed by the serving RAN node, or vice versa.

For example, an AE-based CSI feedback/report can be implemented by a two-sided AI/ML model. The encoder (first part of the two-sided model) is operated at a UE to compress the wireless channel estimate, with the compressed wireless channel estimates being sent from the UE to the serving RAN node, which uses a decoder (second part of two-sided model) to reconstruct the estimated wireless channel information. This use case may be referred to as “two-sided CSI-compression”.

When applying AI/ML on air interface use cases, different levels of collaboration between RAN nodes and UEs can be considered. One example is no collaboration, where a proprietary ML model operating with the existing air-interface standards is applied at one end of the communication chain (e.g., at UE) and the model LCM (e.g., model selection/training, model monitoring, model retraining, model update) is performed at this end without assistance (e.g., information provided by a RAN node).

Another example is limited collaboration between RAN nodes and UEs for one-sided models. In this case, a ML model is being used at one end of the communication chain (e.g., at UE), but with some LCM assistance from the other end of the communication chain (e.g., RAN node). For example, LCM assistance can be for training/retraining the AI model, model update, model monitoring, model selection/fallback/switching, etc.

Another example is joint operation between RAN nodes and UEs for two-sided models. In this case, it is assumed that the AI/ML model is split with one part located in the RAN and the other part located at the UE. This arrangement requires joint inference between RAN and UE, and LCM involves both entities.

In a recent 3GPP RANI working group meeting, it was agreed to use the legacy CSI reporting framework (including CBSR discussed above) as a starting point for AI-based CSI reporting. For example, in the CSI compression using two-sided model use case, for the study of UCI format, it was agreed to consider the legacy CSI reporting principle with CSI Part 1 and Part 2 as a starting point, where Part 1 has a network configured fixed size and Part 2 size is dynamic, determined by information in Part 1.

While legacy CSI reporting is based on the channel information in beam or beam-delay domains, an AI-based CSI report can constitute channel information (e.g., estimates) in the form of raw eigenvectors in spatial-frequency domain. In the recent 3GPP RANI working group meeting, it was agreed to further study CBSR for AI-CSI report based on channel information in spatial-frequency domain. For example, in CSI compression using two-sided model use case, further study was agreed for the feasibility various CBSR methods, including the following:
input-CSI-NW/output-CSI-UE is in angular-delay domain, beam restriction can be based on legacy SD basis vector-based input CSI in angular domain;
For further study (FFS): amplitude restriction; and
FFS: if input-CSI-NW/output-CSI-UE is in spatial-frequency domain.
   Although further study has been agreed for these techniques, there are no proposed solutions for CBSR for AI-CSI based on channel information in spatial-frequency domain, such as raw eigenvectors.

Embodiments of the present disclosure address these and other problems, issues, and/or difficulties by providing techniques for the RAN to configure a UE for AI-based CSI reporting based on CBSR, which prevents the UE from including unwanted channel information in the AI-CSI report. In particular, the RAN can configure a restriction of a subspace of a MIMO channel, which prevents the UE from providing CSI feedback for this restricted subset to the RAN. For example, the RAN can configure a restriction on transmission layer information such as raw eigenvectors in spatial-frequency domain or preprocessed eigenvectors in beam-delay domain.

Embodiments of the present disclosure can provide various benefits, advantages, and/or solutions to various problems. At a high level, embodiments can facilitate efficient AI-based CSI feedback in the spatial-frequency domain. For example, a RAN node can control interference in certain spatial (beam) directions by restricting a UE from selecting a PMI corresponding to these directions (e.g., toward UEs of a neighboring cell). By use of CBSR in spatial-frequency domain, embodiments also facilitates reduced complexity for the UE to construct a CSI report and efficiently manage UCI payload for CSI reporting. Due to these advantages, embodiments can improve the overall performance of MU-MIMO used to transmit DL data to multiple UEs concurrently.

Various embodiments will now be described in more detail. In general, embodiments are relevant to a scenario where a UE estimates a DL channel based on the configured DL reference signals (e.g., CSI-RS, DMRS, etc.), and produces a channel estimate, H, in the spatial-frequency domain. The raw channel H can be expressed per CSI-RS port (TX side), per receive antenna (RX side), and per frequency sub-band, and can be measured at one or more points in time. Hence, in the most general case, the channel H is a four-dimensional matrix or tensor.

The raw channel estimate H is used to estimate the appropriate DL transmission rank r=min(rₘᵢₙ, N_{Tx}, N_{Rx}), where rₘᵢₙ is a rank restriction configured by the serving RAN node, N_{Tx} is the number of CSI-RS port at the RAN node, and N_{Rx} is the number of receive ports at the UE. Furthermore, H is processed to extract eigenvectors corresponding to respective layers of the estimated rank r. These eigenvectors are denoted by eᵣ_{ᵢ}, where rᵢ=1, 2, . . . , r. Note that eᵣ_{ᵢ} is a tensor with dimension equal to N_{Tx} times N_{Rx} times number of frequency subbands.

The extracted eᵣ_{ᵢ} are compressed and quantized into bits by the UE encoder. Subsequently, the concatenated bits across all the layers are reported back to RAN node along with the rank indication (RI) as part of the uplink CSI report. The RAN node decoder uses this information to reconstruct the eigenvectors per layer, denoted by êᵣ_{ᵢ}. The RAN node can also process the eigenvectors to obtain precoders for each layer, pᵣ_{ᵢ}, for the transmission of PDSCH.

In the present disclosure, the term “eigenvector” refers to per-layer input of the encoder. However, this term can refer to different types of precoding information extracted by the UE for different layers, such as the following examples:
1. Eigenvectors of the transmit covariance corresponding to the raw channel H, for a fixed frequency index, and in the most general case also a fixed time index. This is equivalent to the singular vectors of the raw channel H.
2. Eigenvectors of an (weighted) averaged transmit covariance of the channel H estimated over different time and/or frequency resources. For example, the aggregation can be averaging the covariance matrices over 2, 4, or 8 resource blocks (RBs) in frequency. As another example, singular vectors of a (weighted) averaged of the channel H estimated over different time and/or frequency resources.
3. Approximations of eigenvectors expressed in a reduced beam-space, corresponding to a set of DFT-vectors. The approximate eigenvectors can correspond to examples 1 or 2 above.
4. Approximations of eigenvectors expressed in a reduced beam-space, corresponding to a set of DFT-vectors, with further compression in time-domain using DFT-bases.

When eigenvectors are pre-processed to be in beam-delay domain as in examples 3 and 4 above, conventional CBSR can be used by the RAN node to signal the beams and/or amplitude corresponding to beam across the frequency subbands to avoid and/or restrict the DL transmission in the unwanted direction. However, the question on how to configure CBSR when the eigenvectors are in spatial-frequency domain has not been addressed, and embodiments of the present disclosure provide CBSR for the case when eigenvectors in spatial-frequency domain are included in the AI-CSI report.

In the following description of various embodiments, it is assumed that when eigenvectors eᵣ_{ᵢ} having a dimension N_{Tx}×1 are used directly as the precoder at the RAN node, the first (N_{Tx}/2×1) elements are applied to the CSI-RS ports across a first polarization (e.g., vertical) and the remaining (N_{Tx}/2×1) elements are applied to the CSI-RS ports across a different second polarization (e.g., horizontal).

Although the following description of various embodiments refers to operations performed by a RAN node, it should be understood that certain portions of these operations could be performed by parts of a RAN node (e.g., CU and/or DU) or could be performed by other appropriate network nodes, such as a core network node that is arranged to perform ML-related operation. A network data analytics function is one example of such a core network node.

In some embodiments, the RAN node can configure CBSR via an index of a beam in an unwanted direction, such as in legacy CBSR method for Type-I CSI report. In such case, the UE removes from the AI-CSI report the eigenvectors having a high correlation with the indicated restricted beams. For example, the RAN node can configure the UE with a size N₁N₂O₁O₂ bitmap, where each bit in the bitmap indicates restriction of a corresponding 2D DFT beam v_{l,m}.

In this example, N₁ and N₂ are numbers of ports along first (e.g., horizontal) and second (e.g., vertical) dimensions, respectively, such that N_{Tx}=2N₁N₂ with the factor 2 accounting for each antenna port comprising two ports with orthogonal polarizations. Additionally, O₁ and O₂ are oversampling factors used to generate the 2D DFT beams v_{l,m} of size (N_{Tx}/2×1), which are defined in 3GPP TS 38.214 (v17.6.0) as:

$${v}_{l , m} = {[ {u}_{m} , {e}^{j \frac{2 π l}{{O}_{1} {N}_{1}}} {u}_{m} , … , {e}^{j \frac{2 π l ( {N}_{1} - 1 )}{{O}_{1} {N}_{1}}} {u}_{m} ]}^{T}$$

such that

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} {u}_{m} ]$$

$$and l ∈ \{ 0 , … , {N}_{1} - 1 \} , m ∈ \{ 0 , … , {N}_{2} - 1 \} .$$

Accordingly, the RAN node can signal the restricted beams v_{l,m}, defined by a pair {l, m}, with the bitmap.

In some embodiments, the RAN node can configure the UE with a threshold, ζ, that restricts the inclusion of eigenvectors in the AI-CSI report. For example, the UE can compute a generalized cosine similarity (GCS) between the restricted beams indicated by the RAN node and the eigenvectors obtained from the estimated channel over the frequency subbands, according to the following equation:

$${p}_{{r}_{i}} = f ( {v}_{\overline{l} , \overline{m}} , {e}_{{r}_{i , f}} ) = \frac{1}{4 \cdot \vert R \vert \cdot {N}_{3}} {\sum }_{\{ \overline{l} , \overline{m} \} ∈ R} {\sum }_{n ϵ \{ 0 , 1 , 2 , 3 \}} {\sum }_{f ∈ \{ 0 , … , {N}_{3} - 1 \}} \frac{\vert {[ \begin{matrix}{v}_{\overline{l} , \overline{m}} \\ {φ}_{n} {v}_{\overline{l} , \overline{m}}\end{matrix} ]}^{H} {e}_{{r}_{i} , f} \vert}{‖ [ \begin{matrix}{v}_{\overline{l} , \overline{m}} \\ {φ}_{n} {v}_{\overline{l} , \overline{m}}\end{matrix} ] ‖ ‖ {e}_{{r}_{i} , f} ‖} ,$$

where
r=min (rₘᵢₙ, N_{Tx}, N_{Rx}) is the maximum allowed rank, with rₘᵢₙ being the rank restriction configured by RAN node, N_{Tx} being the number of CSI-RS port at the RAN node and N_{Rx} being the receive ports at the UE,
eᵣ_{ᵢ}_{,f}, rᵢ=1, 2, . . . r, is the eigenvector at the f-th subband computed at the UE from the estimated channel,
ρᵣ_{ᵢ} is the GCS value for the rᵢ-th eigenvector eᵣ_{ᵢ}_{,f} of across all the frequency bands,
v_{l̅,m̅} is the restricted 2D beam indicated by RAN node and R is the set of all the indices signaled by the RAN node defining the restricted beams,
φₙ is the possible co-phasing of beams across the polarization, that may take four possible values of {1, j,−1,−j} (generally can have one or more co-phasing factors) and
N₃ is the number of frequency subbands over which the CSI-report is computed.

Although f(v_{l̅,m̅}, e_{r,f}) is the GCS function in this example, other functions like squared generalized cosine similarity (SCGS), Euclidean cosine similarity (ECS), squared Euclidean cosine similarity (SECS), normalized mean square error (NMSE), etc. may be used to compute ρᵣ_{ᵢ}. Accordingly, an eigenvector eᵣ_{ᵢ}_{,f}, ∀f, can be included in the CSI report only when ρᵣ_{ᵢ}<ζ, such that the criteria to exclude an eigenvector can depend on the function used to define f(v_{l̅,m̅}, eᵣ_{ᵢ}_{,f}).

In some embodiments, the threshold can take on any of one or multiple pre-defined values, where the specific threshold value is indicated to the UE by the RAN node. In other embodiments, the value of threshold ζ can be a function of configured parameters such as rank r, number of subbands N₃, number of CSI-RS ports N_{Tx}, etc., the eigenvalue of the corresponding eigenvectors and/or the AI model used for the AI-CSI report.

Consider an example scenario where 10000 samples of eigenvectors (obtained from independent channel realizations) of dimension (N_{Tx}×N₃×r)=(32,13,4) are obtained. The eigenvectors per subband for a sample are arranged in descending order of their corresponding eigenvalues. FIG. 12 shows a cumulative density function (CDF) for ρᵣ_{ᵢ} when rᵢ=1. In particular, FIG. 12 shows the CDF of the GCS for the dominant eigenvector where the beam v_{l̅,m̅} with (l̅,m̅)=(0, 0) is assumed to be the restricted beam. Accordingly, if the RAN node selects a threshold ζ=0.25, FIG. 12 shows that for around 15% of the channels, the transmission over the dominant eigenvector is restricted and hence cannot be included in the AI-CSI report.

In some embodiments, the CBSR can be imposed by configuring one or more restricted beams and removing their correlation with the computed eigenvectors at the UE. For example, given an eigenvector eᵣ_{ᵢ}_{,f}, Gram Schmidt Orthonormalization can be applied using the following relation to obtain an eigenvector ēᵣ_{ᵢ}_{,f} that is orthogonal to the restricted beam direction in all the N₃ frequency subbands:

$${\overline{e}}_{{r}_{i} , f} = \frac{{e}_{{r}_{i} , f} - {\sum }_{\{ \overline{l} , \overline{m} \} ∈ R} {\sum }_{n ∈ \{ 0 , 1 , 2 , 3 \}} {proj}_{[ \begin{matrix}{v}_{l , m} \\ {φ}_{n} {v}_{l , m}\end{matrix} ]} ( {e}_{{r}_{i} , f} )}{‖ {e}_{{r}_{i} , f} - {\sum }_{\{ \overline{l} , \overline{m} \} ∈ R} {\sum }_{n ∈ \{ 0 , 1 , 2 , 3 \}} {proj}_{[ \begin{matrix}{v}_{l , m} \\ {φ}_{n} {v}_{l , m}\end{matrix} ]} ( {e}_{{r}_{i} , f} ) ‖} ,$$

where

$${proj}_{[ \begin{matrix}{v}_{l , m} \\ {φ}_{n} {v}_{l , m}\end{matrix} ]} ( {e}_{{r}_{i} , f} ) = \frac{< {e}_{{r}_{i} , f} , [ \begin{matrix}{v}_{l , m} \\ {φ}_{n} {v}_{l , m}\end{matrix} ] >}{< [ \begin{matrix}{v}_{l , m} \\ {φ}_{n} {v}_{l , m}\end{matrix} ] , [ \begin{matrix}{v}_{l , m} \\ {φ}_{n} {v}_{l , m}\end{matrix} ] >} [ \begin{matrix}{v}_{l , m} \\ {φ}_{n} {v}_{l , m}\end{matrix} ]$$

and <e, v> denotes the inner product of the vector e and v, and
the other parameters are defined as above.

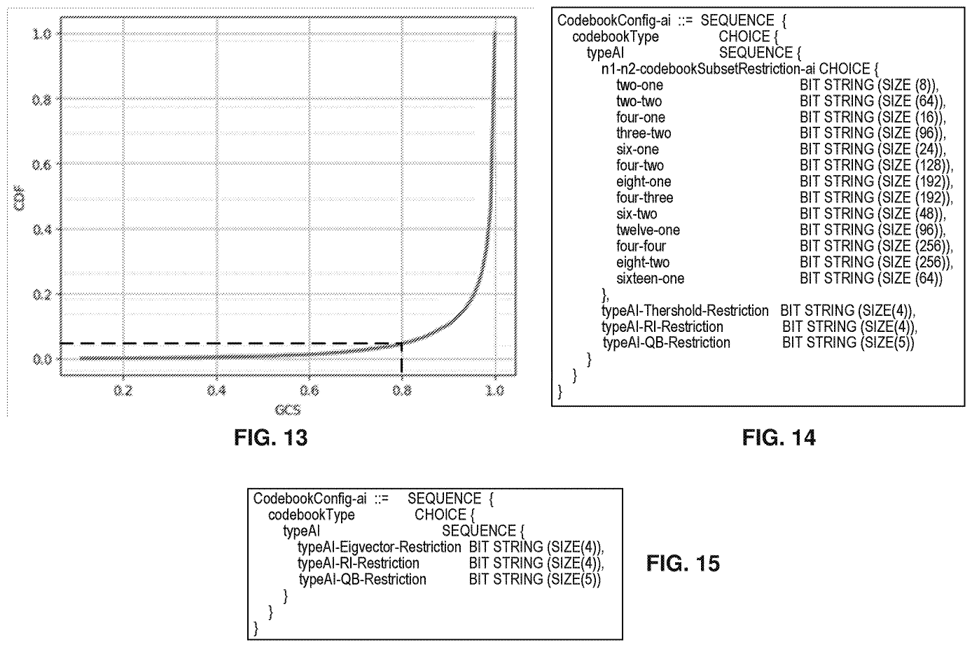

Consider the same example scenario as above where 10000 samples of eigenvectors (from independent channel realizations) of dimension (N_{Tx}×N₃×r)=(32,13,4) are obtained. The eigenvectors per subband for a sample are arranged in descending order of their corresponding eigenvalues. In FIG. 13 shows a CDF for GCS between eᵣ_{ᵢ}_{,f} and ēᵣ_{ᵢ}_{,f} (for the dominant eigenvector) averaged across all subbands. It can be observed that after removing the correlation with respect to the restricted beam, more than 95% of the eigenvectors maintain a GCS>80% with the original eigenvectors.

In some embodiments, the eigenvectors that need to be restricted from the AI-CSI report can be approximately estimated by the RAN node using UL measurements and some degree of reciprocity. For example, the RAN node can estimate the UL channel based on UE-transmitted sounding RS (SRS) and compute the corresponding eigenvectors, which can be used to estimate the dominant eigen directions. This gives the RAN node an approximation of which eigen directions to avoid, based on the relative strength of eigenvectors according to their corresponding eigenvalues. Based on this approximation, the RAN node can indicate indices of the eigenvectors to avoid (or include), assuming that the UE also arranges its computed eigenvectors in a corresponding manner based on their respective eigen values.

In some embodiments, the eigenvectors that need to be restricted depend on the AI-CSI model selected for the generating the AI-CSI report. For example, assume model X with a pre-defined capability of efficiently compressing the dominant k≤r eigenvectors is selected to generate the AI-CSI report. The RAN node can signal a restriction to the first k dominant eigenvectors to be included in the AI-CSI report, e.g., using a bitmap. This approach may be beneficial since compression performance may differ for different transmission layers since the eigenvectors across transmission layers can have different distributions.

Note that the number of eigenvectors k can be the same as the rank restriction when RRC configured or can be dynamically configured via MAC CE or DCI when the RAN node decides to change the AI model that the UE uses to generate the AI-CSI report. This change can be based on model monitoring during inference, for example.

In some embodiments, when CBSR is configured by the RAN node (e.g., as a restricted subspace via indices of beams in unwanted directions), the UE nevertheless reports all eigenvectors in an unrestricted manner but also indicates the impacts of the respective eigenvectors on the restricted subspace. For example, the impact for each eigenvector can be reported as the value ρᵣ_{ᵢ}. Rather than using a threshold to restrict reporting, the RAN node can determine whether each of the eigenvectors is harmful before using it to generate precoding for DL transmission.

The RAN node can configure the UE to provide AI-CSI using the RRC CodebookConfig IE. For example, the RAN node can explicitly configure parameters such as model ID, number of quantization bits to use per transmission layer at the UE, any restrictions on the reported rank and/or the precoder, etc. FIG. 14 shows an ASN.1 data structure for a CodebookConfig-ai information element (IE) according to these embodiments. This IE includes an n1-n2-codebookSubsetRestriction-ai field, which includes a variable-size bitmap that can be used to indicate beams to be avoided in the AI-CSI report. The signaling of the unwanted beams through the bit map is similar to the signaling of CBSR of the legacy Type-I codebook.

In some embodiments, a new parameter called typeAI-Threshold-Restriction (or similar) can be included in CodebookConfig IE when the UE is configured to report AI-CSI. For example, this parameter can have integer values 0 to n−1 that correspond to n possible values of threshold. As a more specific example, two bits can provide the four integer values {0,1,2,3} that corresponding to four predefined values ζ∈€{0.1, 0.25, 0.5, 0.75}.

In the example shown in FIG. 14, typeAI-Threshold-Restriction is a bit map of length 4, where each bit corresponds to one of the predefined threshold values. For example, a bit map of [0 0 1 0] can be used to indicate threshold ξ=0.5.

As discussed in the previous section, the RAN node may restrict the eigenvectors included in the AI-CSI report by signaling the index of the eigenvectors (arranged in descending or acceding order of their corresponding eigenvalues). In some embodiments, a new parameter called typeAI-Eigenvector-Restriction (or similar name) can be included in CodebookConfig 1E when the UE is configured to report AI-CSI. For example, this parameter can be a bit map of length r, where r is the maximum possible rank. In the bitmap, each bit can indicate which eigenvectors can be eliminated for the AI-CSI report. FIG. 15 shows an ASN.1 data structure for a CodebookConfig-ai IE according to these embodiments.

As an illustrative example, for a maximum allowed rank r=4, the RAN node may estimate that the second and third strongest eigenvectors (i.e., in descending order of their corresponding eigenvectors) are not suitable for constructing the DL precoder. Accordingly, it can signal this to the UE with a bitmap [1 0 0 1] indicating that these two eigenvectors can be eliminated for the AI-CSI report.

In some embodiments, a UE can send to the RAN node a proposed CBSR configuration (or parameter therein) that is different the its current CBSR configuration (or parameter therein) provided by the RAN node. If the RAN node accepts the UE's proposal, the RAN node can dynamically configure one or more new parameter values via DCI or MAC CE. Alternately, the RAN node may decide to dynamically configure one or more new parameter values via DCI or MAC CE, without input from the UE. For example, if the RAN node wants to change the value of typeAI-Threshold-Restriction (configured initially through RRC) due to a change in channel conditions, it can signal a new value for typeAI-Threshold-Restriction via DCI or MAC-CE.

In some embodiments, the configuration or indication related to the CBSR may be overwritten by other information. For example, the CBSR configuration or indication may not be applied by the UE upon receiving an indication to transmit its target-CSI (ground truth), e.g., to support performance monitoring in the RAN. In such case, the UE may need to transmit CSI-report for all beams rather than for a restricted set according to CBSR (e.g. two strongest beams). In case the ground-truth configuration specifies a maximum number of beams (e.g., three strongest beams) that is greater than the CBSR, the UE can transmit a CSI report for that maximum number.

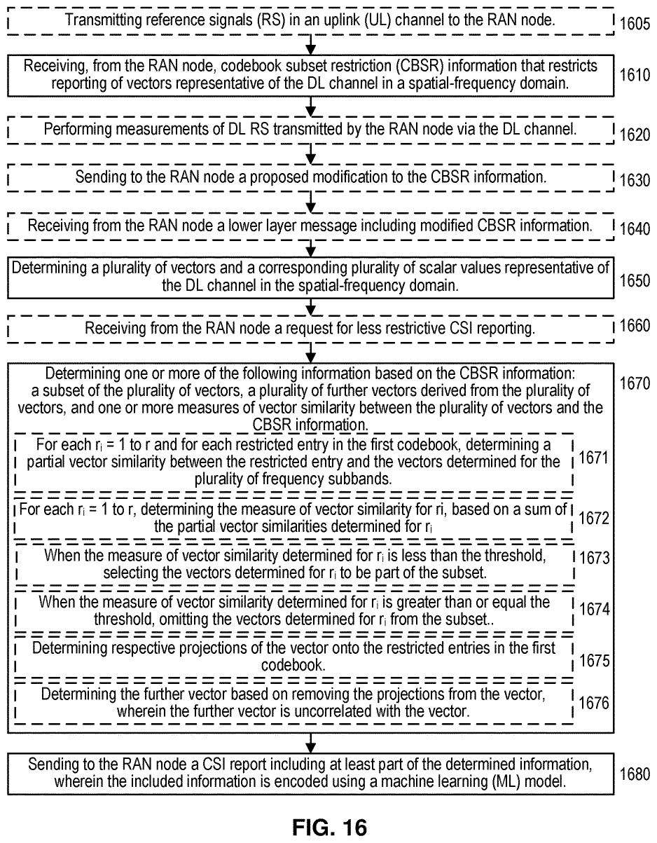

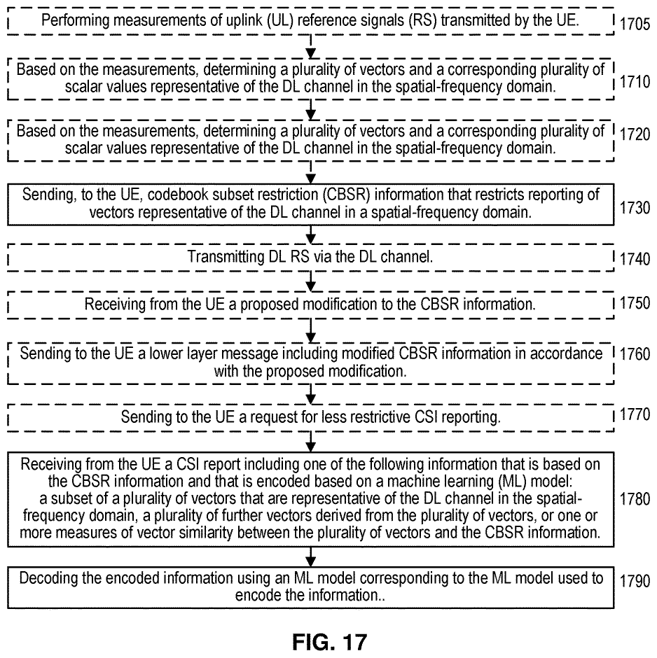

The embodiments described above can be further illustrated with reference to FIGS. 16-17, which show exemplary methods (e.g., procedures) for a UE and a RAN node, respectively. In other words, various features of operations described below correspond to various embodiments described above. These exemplary methods can be used cooperatively to provide various exemplary benefits and/or advantages. Although FIGS. 16-17 show specific blocks in particular orders, the operations of the respective methods can be performed in different orders than shown and can be combined and/or divided into blocks having different functionality than shown. Optional blocks or operations are indicated by dashed lines.

In particular, FIG. 16 shows a flow diagram of an exemplary method (e.g., procedure) for a UE configured to provide CSI reports for a DL channel from a RAN node serving the UE, according to various embodiments of the present disclosure. The exemplary method can be performed by a UE (e.g., wireless device, IoT device, modem, etc. or component thereof) such as described elsewhere herein.

The exemplary method includes the operations of block 1610, where the UE receives from the RAN node codebook subset restriction (CBSR) information that restricts reporting of vectors representative of the DL channel in a spatial-frequency domain. The exemplary method also includes the operations of block 1650, where the UE determine a plurality of vectors and a corresponding plurality of scalar values representative of the DL channel in the spatial-frequency domain. The exemplary method also includes the operations of block 1670, where the UE determines one or more of the following based on the CBSR information: a subset of the plurality of vectors, a plurality of further vectors derived from the plurality of vectors, and one or more measures of vector similarity between the plurality of vectors and the CBSR information.

The exemplary method also includes the operations of block 1680, where the UE sends to the RAN node a CSI report including at least part of the determined information. Specifically, the included information is encoded using a machine learning (ML) model.

In some embodiments, the DL channel is a multiple input multiple output (MIMO) channel and the CBSR information defines a restricted subspace of the MIMO channel. In some embodiments, the plurality of vectors representative of the DL channel in the spatial-frequency domain are eigenvectors, and the corresponding plurality of scalar values are eigenvalues. In some embodiments, the vector similarity (i.e., based on which the one or more measures are determined) is one of the following: generalized cosine similarity (GCS), squared generalized cosine similarity (SCGS), Euclidean cosine similarity (ECS), squared Euclidean cosine similarity (SECS), or normalized mean square error (NMSE).

In some embodiments, the exemplary method can also include operations of block 1650, where the UE can perform measurements of DL RS transmitted by the RAN node via the DL channel. In such case, the plurality of vectors and the corresponding plurality of scalar values are determined in block 1650 based on the measurements.

In some embodiments, the CBSR information includes one or more of the following:
an indication of one or more restricted entries of a first codebook of vectors representing respective spatial beam directions;
an indication of one or more restricted entries of a second codebook of vectors in the spatial-frequency domain;
a threshold for the measure of vector similarity;
a number of the vectors to be selected based on largest corresponding scalar values; and
an identifier of the ML model, which is capable of encoding the number of vectors. In some of these embodiments, the threshold is indicated as one of the following:
one of a plurality of predefined threshold values, or
a function of one or more of the following: a maximum allowed transmission rank, frequency subbands over which the measure of vector similarity is determined, the determined scalar values, and a number of antenna ports used by the RAN node to transmit DL RS via the DL channel (e.g., as measured in block 1620).

In some of these embodiments, the threshold is included in the CBSR information as one of the following:
a bitmap having respective bits corresponding to the plurality of predefined threshold values; or
an integer field that can take on a plurality of values corresponding to the plurality of predefined threshold values.

In some of these embodiments, the indication of the one or more restricted entries of the first codebook comprises one of the following: one or more indices associated with the respective restricted entries, or a bitmap having a number of bits equal to a number of entries in the first codebook. In some of these embodiments, the indication of the one or more restricted entries of the second codebook comprises a bitmap having a plurality of bits corresponding to respective eigenvectors of the second codebook, with the number of bits equal to a maximum allowed transmission rank.

In some of these embodiments, the plurality of vectors are associated with respective different combinations of the following: one of a plurality of frequency subbands of the DL channel, and one of a plurality of transmission ranks, rᵢ=1 to r, where r is a maximum allowed transmission rank. In other words, each vector is associated with a different subband-rank combination than other vectors.

In some variants of these embodiments, the measure of vector similarity is of similarity between the following: the restricted entries in the first codebook, and the vectors associated with the plurality of frequency subbands and a particular transmission rank rᵢ. In some further variants of these embodiments, determining the one or more measures of vector similarity in block 1670 includes the following operations, labelled with corresponding sub-block numbers:
(1671) for each rᵢ=1 to r and for each restricted entry in the first codebook, determining a partial vector similarity between the restricted entry and the vectors determined for the plurality of frequency subbands; and
(1672) for each rᵢ=1 to r, determining the measure of vector similarity for ri, based on a sum of the partial vector similarities determined for rᵢ.

In some further variants, the measures of vector similarity are included in the CSI report together with the plurality of vectors. In other further variants, the subset of the plurality of vectors are included in the CSI report and determining the subset of the plurality of vectors in block 1670 includes the following operations, labelled with corresponding sub-block numbers:
(1673) when the measure of vector similarity determined for rᵢ is less than the threshold, selecting the vectors determined for rᵢ to be part of the subset; and
(1674) when the measure of vector similarity determined for rᵢ is greater than or equal the threshold, omitting the vectors determined for rᵢ from the subset.

In other variants of these embodiments, the plurality of further vectors are included in the CSI report and determining the plurality of further vectors in block 1670 includes the following operations for each of the plurality of vectors (i.e., that are representative of the DL channel in the spatial-frequency domain), labelled with corresponding sub-block numbers:
(1675) determining respective projections of the vector onto the restricted entries in the first codebook; and
(1676) determining the further vector based on removing the projections from the vector, wherein the further vector is uncorrelated with the vector.
   In some further variants, each further vector is determined based on a Gram Schmidt Orthogonalization, such as discussed above.

In some embodiments, wherein the CBSR information is received via radio resource control (RRC) message the exemplary method also includes the operations of blocks 1630-1640, where the UE sends to the RAN node a proposed modification to the CBSR information and receives from the RAN node a lower layer message including modified CBSR information in accordance with the proposed modification. In such case, the information is determined in block 1670 based on the modified CBSR information (i.e., rather than the CBSR information).

In some embodiments, the exemplary method also includes the operations of block 1660, where the UE receives from the RAN node a request for less restrictive CSI reporting. Based on the request, the plurality of vectors representative of the DL channel in the spatial-frequency domain are included in the CSI report in block 1680, instead of at least part of the information determined in block 1670.

In some embodiments, the exemplary method also includes the operations of block 1605, where the UE transmits RS in an uplink (UL) channel to the RAN node. In such case, the CBSR information is received responsive to transmitting the RS. This may be the case, for example, when there is reciprocity between the UL and DL channels.

In addition, FIG. 17 shows a flow diagram of an exemplary method (e.g., procedure) for a RAN node configured to receive CSI reports from a UE for a DL channel to the UE, according to various embodiments of the present disclosure. The exemplary method can be performed by a RAN node (e.g., base station, eNB, gNB, ng-eNB, etc., or components thereof) such as described elsewhere herein.

The exemplary method includes the operations of block 1730, where the RAN node sends, to the UE, CBSR information that restricts reporting of vectors representative of the DL channel in a spatial-frequency domain. The exemplary method also includes the operations of block 1780, where the RAN node receives from the UE a CSI report including one of the following information that is based on the CBSR information and that is encoded based on an ML model:
a subset of a plurality of vectors that are representative of the DL channel in the spatial-frequency domain;
a plurality of further vectors derived from the plurality of vectors; or
one or more measures of vector similarity between the plurality of vectors and the CBSR information.
   The exemplary method also includes the operations of block 1790, where the RAN node decodes the encoded information using an ML model corresponding to the ML model used to encode the information (e.g., a two-sided ML model).

In some embodiments, the DL channel is a MIMO channel and the CBSR information defines a restricted subspace of the MIMO channel. In some embodiments, the plurality of vectors representative of the DL channel in the spatial-frequency domain are eigenvectors. In some embodiments, the vector similarity (i.e., based on which the one or more measures are determined) is one of the following: GCS, SCGS, ECS, SECS, or NMSE.

In some embodiments, the exemplary method also includes the operations of block 1740, where the RAN node transmit DL RS via the DL channel. In such case, the CSI report received in block 1780 is based on the DL RS.

In some embodiments, the CBSR information includes one or more of the following:
an indication of one or more restricted entries of a first codebook of vectors representing respective spatial beam directions;
an indication of one or more restricted entries of a second codebook of vectors in the spatial-frequency domain;
a threshold for the measure of vector similarity;
a number of the vectors to be selected based on largest corresponding scalar values; and
an identifier of the ML model, which is capable of encoding the number of vectors.
an identifier of the ML model, which is capable of encoding the number of eigenvectors. In some of these embodiments, the threshold is indicated as one of the following:
one of a plurality of predefined threshold values, or.
a function of one or more of the following: a maximum allowed transmission rank, frequency subbands over which the measure of vector similarity is determined, scalar values corresponding to the plurality of vectors, and a number of antenna ports used by the RAN node to transmit DL RS via the DL channel (e.g., in block 1740).
   In some of these embodiments, the threshold is included in the CBSR information as one of the following:
a bitmap having respective bits corresponding to the plurality of predefined threshold values; or
an integer field that can take on a plurality of values corresponding to the plurality of predefined threshold values.

In some of these embodiments, the indication of the one or more restricted entries of the first codebook comprises one of the following: one or more indices associated with the respective restricted entries, or a bitmap having a number of bits equal to a number of entries in the first codebook. In some of these embodiments, the indication of the one or more restricted entries of the second codebook comprises a bitmap having a plurality of bits corresponding to respective vectors of the second codebook, with the number of bits equal to a maximum allowed transmission rank.

In some of these embodiments, the plurality of vectors are associated with respective different combinations of the following: one of a plurality of frequency subbands of the DL channel, and one of a plurality of transmission ranks, rᵢ=1 to r, where r is a maximum allowed transmission rank. In other words, each vector is associated with a different subband-rank combination than other vectors.

In some variants of these embodiments the measure of vector similarity is of similarity between the following: the restricted entries in the first codebook, and the vectors associated with the plurality of frequency subbands and with a particular transmission rank rᵢ. In some further variants, the subset of the plurality of eigenvectors (i.e., when received in block 1780) includes the vectors associated with rᵢ, when the measure of vector similarity for the vectors associated with rᵢ is less than the threshold. Likewise, the subset of the plurality of eigenvectors excludes the vectors associated with rᵢ, when the measure of vector similarity for the vectors associated with rᵢ is greater than or equal to the threshold. This functionality is complementary to UE functionality in sub-blocks 1673-1674, discussed above.

In other variants of these embodiments, the received encoded information includes the plurality of vectors and respective measures of vector similarity for the vectors associated with the respective plurality of transmission ranks, rᵢ=1 to r.

In other variants of these embodiments, each further vector (i.e., when received in block 1780) is based on removal of projections of a corresponding one of the plurality of vectors onto the restricted entries of the first codebook, such that the further vector is uncorrelated with the corresponding vector. This functionality is complementary to UE functionality in sub-blocks 1675-1676, discussed above.

In some embodiments, the CBSR information is sent via RRC message and the exemplary method also includes the operations of blocks 1750-1760, where the RAN node receives from the UE a proposed modification to the CBSR information and sends to the UE a lower layer message including modified CBSR information in accordance with the proposed modification. In such case, the received encoded information is based on the modified CBSR information (i.e., instead of the CBSR information).

In some embodiments, the exemplary method also include the operations of block 1770, where the RAN node sends to the UE a request for less restrictive CSI reporting. Based on the request, the encoded information in the CSI report includes the plurality of vectors representative of the DL channel in the spatial-frequency domain, instead of the subset, the plurality of further vectors, or the one or more measures of vector similarity.

In some embodiments, the exemplary method also includes the following operations, labelled with corresponding block numbers:
(1705) performing measurements of UL RS transmitted by the UE;
(1710) based on the measurements, determining a plurality of vectors and a corresponding plurality of scalar values representative of the DL channel in the spatial-frequency domain; and
(1720) based on the corresponding scalar values, selecting one or more of the plurality of vectors that are associated with intercell interference.
   In such embodiments, the CBSR is based on the selected one or more vectors.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

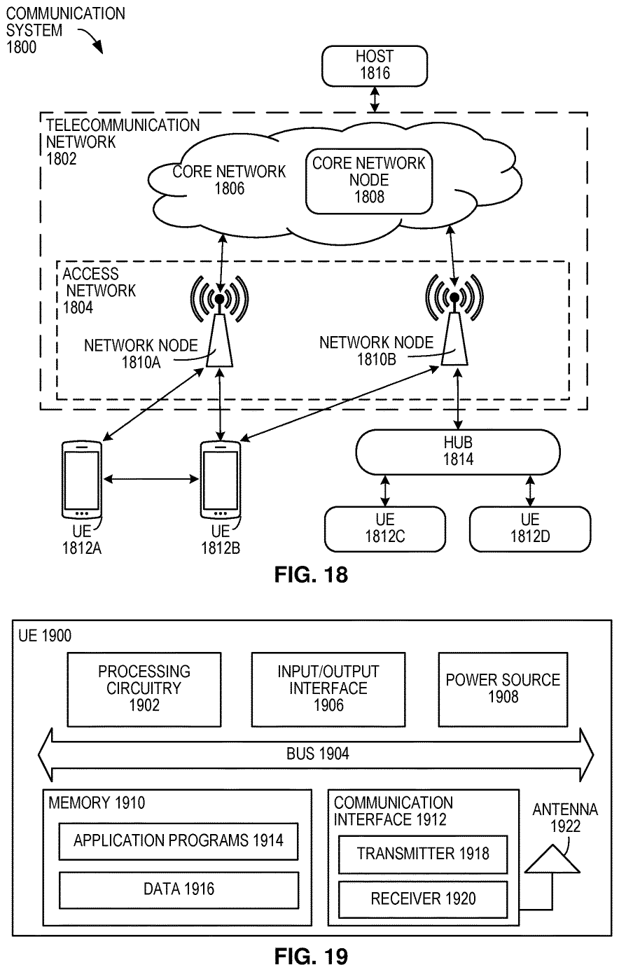

FIG. 18 shows an example of a communication system 1800 in accordance with some embodiments. In this example, communication system 1800 includes a telecommunication network 1802 that includes an access network 1804 (e.g., RAN) and a core network 1806, which includes one or more core network nodes 1808. Access network 1804 includes one or more access network nodes, such as network nodes 1810a-b (one or more of which may be generally referred to as network nodes 1810), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1802 includes one or more Open-RAN (ORAN) network nodes. An ORAN network node is a node in telecommunication network 1802 that supports an ORAN specification (e.g., a specification published by the O-RAN Alliance, or any similar organization) and may operate alone or together with other nodes to implement one or more functionalities of any node in telecommunication network 1802, including one or more network nodes 1810 and/or core network nodes 1808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1810 facilitate direct or indirect connection of UEs, such as by connecting UEs 1812a-d (one or more of which may be generally referred to as UEs 1812) to core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1800 may include any number of wired or wireless networks, network nodes, UEs, and/or any other components or systems that may facilitate or participate in the communication of data and/or signals whether via wired or wireless connections. Communication system 1800 may include and/or interface with any type of communication, telecommunication, data, cellular, radio network, and/or other similar type of system.

UEs 1812 may be any of a wide variety of communication devices, including wireless devices arranged, configured, and/or operable to communicate wirelessly with network nodes 1810 and other communication devices. Similarly, network nodes 1810 are arranged, capable, configured, and/or operable to communicate directly or indirectly with UEs 1812 and/or with other network nodes or equipment in telecommunication network 1802 to enable and/or provide network access, such as wireless network access, and/or to perform other functions, such as administration in telecommunication network 1802.

In the depicted example, core network 1806 connects network nodes 1810 to one or more hosts, such as host 1816. These connections may be direct or indirect via one or more intermediary networks or devices. In other examples, network nodes may be directly coupled to hosts. Core network 1806 includes one or more core network nodes (e.g., 1808) that are structured with hardware and software components. Features of these components may be substantially similar to those described with respect to the UEs, network nodes, and/or hosts, such that the descriptions thereof are generally applicable to the corresponding components of core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1816 may be under the ownership or control of a service provider other than an operator or provider of access network 1804 and/or telecommunication network 1802, and may be operated by the service provider or on behalf of the service provider. Host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1802 is a cellular network that implements 3GPP standardized features. Accordingly, telecommunication network 1802 may support network slicing to provide different logical networks to different devices that are connected to telecommunication network 1802. For example, telecommunication network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1812 are configured to transmit and/or receive information without direct human interaction. For instance, a UE may be designed to transmit information to access network 1804 on a predetermined schedule, when triggered by an internal or external event, or in response to requests from access network 1804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1814 communicates with access network 1804 to facilitate indirect communication between one or more UEs (e.g., 1812c and/or 1812d) and network nodes (e.g., network node 1810b). In some examples, hub 1814 may be a controller, router, content source and analytics, or any of the other communication devices described herein regarding UEs. For example, hub 1814 may be a broadband router enabling access to core network 1806 for the UEs.

As another example, hub 1814 may be a controller that sends commands or instructions to one or more actuators in the UEs. Commands or instructions may be received from the UEs, network nodes 1810, or by executable code, script, process, or other instructions in hub 1814. As another example, hub 1814 may be a data collector that acts as temporary storage for UE data and, in some embodiments, may perform analysis or other processing of the data. As another example, hub 1814 may be a content source. For example, for a UE that is a VR headset, display, loudspeaker or other media delivery device, hub 1814 may retrieve VR assets, video, audio, or other media or data related to sensory information via a network node, which hub 1814 then provides to the UE either directly, after performing local processing, and/or after adding additional local content. In still another example, hub 1814 acts as a proxy server or orchestrator for the UEs, in particular if one or more of the UEs are low energy IoT devices.

Hub 1814 may have a constant/persistent or intermittent connection to network node 1810b. Hub 1814 may also allow for a different communication scheme and/or schedule between hub 1814 and UEs (e.g., 1812c and/or 1812d), and between hub 1814 and core network 1806. In other examples, hub 1814 is connected to core network 1806 and/or one or more UEs via a wired connection. Moreover, hub 1814 may be configured to connect to an M2M service provider over access network 1804 and/or to another UE over a direct connection. In some scenarios, UEs may establish a wireless connection with network nodes 1810 while still connected via hub 1814 via a wired or wireless connection. In some embodiments, hub 1814 may be a dedicated hub—that is, a hub whose primary function is to route communications to/from the UEs from/to network node 1810b. In other embodiments, hub 1814 may be a non-dedicated hub—that is, a device capable of routing communications between the UEs and network node 1810b, but which is additionally capable of operating as a communication start and/or end point for certain data channels.

FIG. 19 shows a UE 1900 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1900 includes processing circuitry 1902 that is operatively coupled via bus 1904 to input/output interface 1906, power source 1908, memory 1910, communication interface 1912, and possibly other components not explicitly shown. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

Processing circuitry 1902 is configured to process instructions and data and may be configured to implement any sequential state machine operative to execute instructions stored as machine-readable computer programs in memory 1910. Processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1902 may include multiple central processing units (CPUs).

In the example, input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1908 is structured as a battery or battery pack. Other types of power sources, such as an external power source (e.g., an electricity outlet), photovoltaic device, or power cell, may be used. Power source 1908 may further include power circuitry for delivering power from power source 1908 itself, and/or an external power source, to the various parts of UE 1900 via input circuitry or an interface such as an electrical power cable. Delivering power may be, for example, for charging of power source 1908. Power circuitry may perform any formatting, converting, or other modification to the power from power source 1908 to make the power suitable for the respective components of UE 1900 to which power is supplied.

Memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1910 includes one or more application programs 1914, such as an operating system, web browser application, a widget, gadget engine, or other application, and corresponding data 1916. Memory 1910 may store, for use by UE 1900, any of a variety of various operating systems or combinations of operating systems.

Memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1910 may allow UE 1900 to access instructions, application programs and the like, stored on transitory or non-transitory memory media, to off-load data, or to upload data. An article of manufacture, such as one utilizing a communication system may be tangibly embodied as or in memory 1910, which may be or comprise a device-readable storage medium.

Processing circuitry 1902 may be configured to communicate with an access network or other network using communication interface 1912. Communication interface 1912 may comprise one or more communication subsystems and may include or be communicatively coupled to an antenna 1922. Communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, transmitter 1918 and receiver 1920 may be coupled to one or more antennas (e.g., 1922) and may share circuit components, software or firmware, or alternatively be implemented separately.

In the illustrated embodiment, communication functions of communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

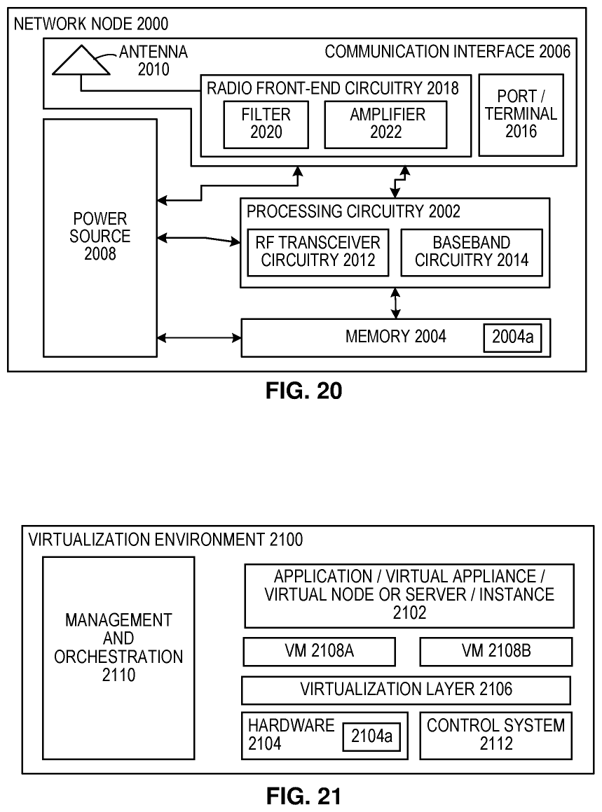

FIG. 20 shows a network node 2000 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 2000 includes processing circuitry 2002, memory 2004, communication interface 2006, and power source 2008. Network node 2000 may be composed of multiple physically separate components (e.g., a NodeB component and a RNC component, or a BTS component and a BSC component, etc.), which may each have their own respective components. In certain scenarios in which network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). Network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

Processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as memory 2004, to provide network node 2000 functionality.

In some embodiments, processing circuitry 2002 includes a system on a chip (SOC). In some embodiments, processing circuitry 2002 includes radio frequency (RF) transceiver circuitry 2012 and/or baseband processing circuitry 2014. In some embodiments, RF transceiver circuitry 2012 and/or baseband processing circuitry 2014 may be on separate chips (or sets of chips), boards, or units, such as radio units and digital units. In alternative embodiments, part or all of RF transceiver circuitry 2012 and/or baseband processing circuitry 2014 may be on the same chip or set of chips, boards, or units.

Memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 2002. Memory 2004 may store any suitable instructions, data, or information, including a computer program, software, an application including one or more of logic, rules, code, tables, and/or other instructions (collected denoted computer program 2004a, which may be in the form of a computer program product) capable of being executed by processing circuitry 2002 and utilized by network node 2000. Memory 2004 may be used to store any calculations made by processing circuitry 2002 and/or any data received via communication interface 2006. In some embodiments, processing circuitry 2002 and memory 2004 is integrated.

Communication interface 2006 is used in wired or wireless communication of signaling and/or data between a network node, access network, and/or UE. As illustrated, communication interface 2006 comprises port(s)/terminal(s) 2016 to send and receive data, for example to and from a network over a wired connection. Communication interface 2006 also includes radio front-end circuitry 2018 that may be coupled to, or in certain embodiments a part of, antenna 2010. Radio front-end circuitry 2018 comprises filters 2020 and amplifiers 2022. Radio front-end circuitry 2018 may be connected to an antenna 2010 and processing circuitry 2002. The radio front-end circuitry may be configured to condition signals communicated between antenna 2010 and processing circuitry 2002. Radio front-end circuitry 2018 may receive digital data that is to be sent out to other network nodes or UEs via a wireless connection. Radio front-end circuitry 2018 may convert the digital data into a radio signal having the appropriate channel and bandwidth parameters using a combination of filters 2020 and/or amplifiers 2022. The radio signal may then be transmitted via antenna 2010. Similarly, when receiving data, antenna 2010 may collect radio signals which are then converted into digital data by radio front-end circuitry 2018. The digital data may be passed to processing circuitry 2002. In other embodiments, the communication interface may comprise different components and/or different combinations of components.

In certain alternative embodiments, network node 2000 does not include separate radio front-end circuitry 2018, instead, processing circuitry 2002 includes radio front-end circuitry and is connected to antenna 2010. Similarly, in some embodiments, all or some of RF transceiver circuitry 2012 is part of communication interface 2006. In still other embodiments, communication interface 2006 includes one or more ports or terminals 2016, radio front-end circuitry 2018, and RF transceiver circuitry 2012, as part of a radio unit (not shown), and communication interface 2006 communicates with baseband processing circuitry 2014, which is part of a digital unit (not shown).

Antenna 2010 may include one or more antennas, or antenna arrays, configured to send and/or receive wireless signals. Antenna 2010 may be coupled to radio front-end circuitry 2018 and may be any type of antenna capable of transmitting and receiving data and/or signals wirelessly. In certain embodiments, antenna 2010 is separate from network node 2000 and connectable to network node 2000 through an interface or port.

Antenna 2010, communication interface 2006, and/or processing circuitry 2002 may be configured to perform any receiving operations and/or certain obtaining operations described herein as being performed by the network node. Any information, data and/or signals may be received from a UE, another network node and/or any other network equipment. Similarly, antenna 2010, communication interface 2006, and/or processing circuitry 2002 may be configured to perform any transmitting operations described herein as being performed by the network node. Any information, data and/or signals may be transmitted to a UE, another network node and/or any other network equipment.

Power source 2008 provides power to the various components of network node 2000 in a form suitable for the respective components (e.g., at a voltage and current level needed for each respective component). Power source 2008 may further comprise, or be coupled to, power management circuitry to supply the components of network node 2000 with power for performing the functionality described herein. For example, network node 2000 may be connectable to an external power source (e.g., the power grid, an electricity outlet) via an input circuitry or interface such as an electrical cable, whereby the external power source supplies power to power circuitry of power source 2008. As a further example, power source 2008 may comprise a source of power in the form of a battery or battery pack which is connected to, or integrated in, power circuitry. The battery may provide backup power should the external power source fail.

Embodiments of network node 2000 may include additional components beyond those shown in FIG. 20 for providing certain aspects of the network node's functionality, including any of the functionality described herein and/or any functionality necessary to support the subject matter described herein. For example, network node 2000 may include user interface equipment to allow input of information into network node 2000 and to allow output of information from network node 2000. This may allow a user to perform diagnostic, maintenance, repair, and other administrative functions for network node 2000.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2100 includes components defined by the O-RAN Alliance, such as an O-Cloud environment orchestrated by a Service Management and Orchestration Framework via an O-2 interface.

Applications 2102 (which may alternatively be called software instances, virtual appliances, network functions, virtual nodes, virtual network functions, etc.) are run in the virtualization environment 2100 to implement some of the features, functions, and/or benefits of some of the embodiments disclosed herein.

Hardware 2104 includes processing circuitry, memory that stores software and/or instructions (collected denoted computer program 2104a, which may be in the form of a computer program product) executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a-b (one or more of which may be generally referred to as VMs 2108), and/or perform any of the functions, features and/or benefits described in relation with some embodiments described herein. Virtualization layer 2106 may present a virtual operating platform that appears like networking hardware to the VMs 2108.

VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2108 may be a software implementation of a physical machine that runs programs as if they were executing on a physical, non-virtualized machine. Each VM 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of hardware 2104 and corresponds to application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration function 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured to provide channel state information (CSI) reports for a downlink (DL) channel from a radio access network (RAN) node serving the UE, the method comprising:
   receiving, from the RAN node, codebook subset restriction (CBSR) information that restricts reporting of eigenvectors representative of the DL channel from the RAN node;
   performing measurements of DL reference signals (RS) transmitted by the RAN node via the DL channel;
   based on the measurements, determining a plurality of eigenvectors and a corresponding plurality of eigenvalues representative of the DL channel;
   selecting a subset of the plurality of eigenvectors based on the CBSR information and encoding the selected eigenvectors using a machine learning (ML) model; and
   sending to the RAN node a CSI report including the encoded eigenvectors.
A2. The method of embodiment A1, wherein the DL channel is a multiple input multiple output (MIMO) channel and the CBSR information defines a restricted subspace of the MIMO channel.
A3. The method of any of embodiments A1-A2, wherein the CBSR information includes one or more of the following:
   an indication of one or more restricted entries of a first codebook of vectors representing respective spatial beam directions;
   an indication of one or more restricted entries of a second codebook of eigenvectors;
   a threshold for a function of eigenvectors associated with a transmission rank;
   a number of eigenvectors to be selected based on largest eigenvalues; and
   an identifier of the ML model, which is capable of encoding the number of eigenvectors.
A3a. The method of embodiment A3, wherein the threshold is indicated as one of the following:
   one of a plurality of predefined threshold values, or
   a function of one or more of the following: the maximum allowed transmission rank, the plurality of frequency subbands, the determined eigenvalues, and a number of antenna ports used by the RAN node to transmit the DL RS.
A3b. The method of embodiment A3a, wherein the CBSR information includes one of the following:
   a bitmap having respective bits corresponding to the plurality of predefined threshold values; or
   an integer field that can take on a plurality of values corresponding to the plurality of predefined threshold values.
A3c. The method of any of embodiments A3-A3b, wherein the indication of the one or more restricted entries of the first codebook comprises one of the following:
   one or more indices associated with the respective restricted entries; or
   a bitmap having a number of bits equal to the number of entries in the first codebook.
A3d. The method of any of embodiments A3-A3c, wherein the indication of the one or more restricted entries of the second codebook comprises a bitmap having a plurality of bits corresponding to respective eigenvectors of the second codebook, with the number of bits equal to a maximum allowed transmission rank.
A3e. The method of any of embodiments A3-A3d, wherein the eigenvectors are determined for each of a plurality of transmission ranks, rᵢ=1 to r, and for each of a plurality of frequency subbands comprising the DL channel, where r is a maximum allowed transmission rank.
A3f. The method of embodiment A3e, wherein the function is a generalized cosine similarity (GCS) between the following:
   a restricted entry in the first codebook of vectors; and
   the plurality of eigenvectors determined for a particular transmission rank rᵢ and for the plurality of frequency subbands.
A3g. The method of embodiment A3f, wherein selecting the subset of the plurality of eigenvectors comprises:
   for each rᵢ=1 to r and for each restricted entry in the first codebook, determining the GCS between the restricted entry and the eigenvectors determined for the plurality of frequency subbands; and
   selecting the eigenvectors determined for rᵢ when the GCS function determined for rᵢ is less than the threshold.
A3h. The method of embodiment A3e, wherein the function is a generalized cosine similarity (GCS) between the following:
   a restricted entry in the first codebook of vectors; and
   further eigenvectors that are orthogonal to the plurality of eigenvectors determined for a particular transmission rank rᵢ and for the plurality of frequency subbands.
A3i. The method of embodiment A3h, wherein selecting the subset of the plurality of eigenvectors comprises:
   for each determined eigenvector and for each restricted entry in the first codebook, determining a further eigenvector that is orthogonal to the vector of the restricted entry in the first codebook;
   for each rᵢ=1 to r and for each restricted entry in the first codebook, determining the GCS between the restricted entry and the further eigenvectors determined for the plurality of frequency subbands; and
   selecting the eigenvectors determined for rᵢ when the GCS function determined for rᵢ is greater than the threshold.
A4. The method of any of embodiments A1-A3i, further comprising:
   sending to the RAN node a proposed modification to the CBSR information; and
   receiving from the RAN node a lower layer message including modified CBSR information in accordance with the proposed modification,
   wherein selecting the subset of the plurality of eigenvectors is based on the modified CBSR information rather than the CBSR information.
A5. The method of any of embodiments A1-A4, further comprising:
   receiving from the RAN node a request for less restrictive CSI reporting; and
   based on the request, refraining from selecting a subset according to the CBSR and encoding all of the determined eigenvectors using the ML model.
B1. A method for a radio access network (RAN) node configured to receive channel state information (CSI) reports from a user equipment (UE) for a downlink (DL) channel to the UE, the method comprising:
   sending, to the UE, codebook subset restriction (CBSR) information that restricts reporting of eigenvectors representative of the DL channel to the UE;
   transmitting DL reference signals (RS) via the DL channel;
   receiving from the UE a CSI report including an encoded subset of a plurality of eigenvectors representative of the channel based on the transmitted RS, wherein the subset is selected by the UE based on the CBSR information and encoded by the UE using a machine learning (ML) model; and
   decoding the encoded subset of eigenvectors using a corresponding ML model.
B2. The method of embodiment B1, wherein the DL channel is a multiple input multiple output (MIMO) channel and the CBSR information defines a restricted subspace of the MIMO channel.
B3. The method of any of embodiments B1-B2, wherein the CBSR information includes one or more of the following:
   an indication of one or more restricted entries of a first codebook of vectors representing respective spatial beam directions;
   an indication of one or more restricted entries of a second codebook of eigenvectors;
   a threshold for a function of eigenvectors associated with a transmission rank;
   a number of eigenvectors to be selected based on largest eigenvalues; and
   an identifier of the ML model, which is capable of encoding the number of eigenvectors.
B3a. The method of embodiment B3, wherein the threshold is indicated as one of the following:
   one of a plurality of predefined threshold values, or
   a function of one or more of the following: the maximum allowed transmission rank, the plurality of frequency subbands, the determined eigenvalues, and a number of antenna ports used by the RAN node to transmit the DL RS.
B3b. The method of embodiment B3a, wherein the CBSR information includes one of the following:
   a bitmap having respective bits corresponding to the plurality of predefined threshold values; or
   an integer field that can take on a plurality of values corresponding to the plurality of predefined threshold values.
B3c. The method of any of embodiments B3-B3b, wherein the indication of the one or more restricted entries of the first codebook comprises one of the following:
   one or more indices associated with the respective restricted entries; or
   a bitmap having a number of bits equal to the number of entries in the first codebook.
B3d. The method of any of embodiments B3-B3c, wherein the indication of the one or more restricted entries of the second codebook comprises a bitmap having a plurality of bits corresponding to respective eigenvectors of the second codebook, with the number of bits equal to a maximum allowed transmission rank.
B3e. The method of any of embodiments B3-B3d, wherein the plurality of eigenvectors representative of the channel are for each of a plurality of transmission ranks, rᵢ=1 to r, and for each of a plurality of frequency subbands comprising the DL channel, where r is a maximum allowed transmission rank.
B3f. The method of embodiment B3e, wherein the function is a generalized cosine similarity (GCS) between the following:
   a restricted entry in the first codebook of vectors; and
   the plurality of eigenvectors determined for a particular transmission rank rᵢ and for the plurality of frequency subbands.
B3g. The method of embodiment B3f, wherein the subset of the plurality of eigenvectors comprises, for each rᵢ=1 to r, the eigenvectors determined for rᵢ when the GCS function determined for rᵢ is less than the threshold.
B3h. The method of embodiment B3e, wherein the function is a generalized cosine similarity (GCS) between the following:
   a restricted entry in the first codebook of vectors; and
   further eigenvectors that are orthogonal to the plurality of eigenvectors determined for a particular transmission rank rᵢ and for the plurality of frequency subbands.
B3i. The method of embodiment B3h, wherein the subset of the plurality of eigenvectors comprises, for each rᵢ=1 to r, the eigenvectors determined for rᵢ when the GCS function determined for rᵢ is greater than the threshold.
B4. The method of any of embodiments B1-B3i, further comprising:
   receiving from the UE a proposed modification to the CBSR information; and
   sending to the UE a lower layer message including modified CBSR information in accordance with the proposed modification,
   wherein the received subset of the plurality of eigenvectors is selected by the UE based on the modified CBSR information rather than the CBSR information.
B5. The method of any of embodiments B1-B4, further comprising sending to the UE a request for less restrictive CSI reporting, wherein in response to the request, the CSI report includes all rather than the subset of the plurality of eigenvectors, encoded using the ML model.
C1. A user equipment (UE) configured to provide channel state information (CSI) reports for a downlink (DL) channel from a radio access network (RAN) node serving the UE, the UE comprising:
   communication interface circuitry configured to communicate with the RAN node; and
   processing circuitry operatively coupled to the communication interface circuitry, whereby the processing circuitry and the communication interface circuitry are configured to perform operations corresponding to any of the methods of embodiments A1-A5.
C2. A user equipment (UE) configured to provide channel state information (CSI) reports for a downlink (DL) channel from a radio access network (RAN) node serving the UE, the UE being further configured to perform operations corresponding to any of the methods of embodiments A1-A5.
C3. A non-transitory, computer-readable medium storing computer-executable instructions that, when executed by processing circuitry of a user equipment (UE) configured to provide channel state information (CSI) reports for a downlink (DL) channel from a radio access network (RAN) node serving the UE, configure the UE to perform operations corresponding to any of the methods of embodiments A1-A5.
C4. A computer program product comprising computer-executable instructions that, when executed by processing circuitry of a user equipment (UE) configured to provide channel state information (CSI) reports for a downlink (DL) channel from a radio access network (RAN) node serving the UE, configure the UE to perform operations corresponding to any of the methods of embodiments A1-A5.
D1. A radio access network (RAN) node configured to receive channel state information (CSI) reports from a user equipment (UE) for a downlink (DL) channel to the UE, the RAN node comprising:
   communication interface circuitry configured to communicate with the UE; and
   processing circuitry operatively coupled to the communication interface circuitry, whereby the processing circuitry and the communication interface circuitry are configured to perform operations corresponding to any of the methods of embodiments B1-B5.
D2. A radio access network (RAN) node configured to receive channel state information (CSI) reports from a user equipment (UE) for a downlink (DL) channel to the UE, the RAN node being further configured to perform operations corresponding to any of the methods of embodiments B1-B5.
D3. A non-transitory, computer-readable medium storing computer-executable instructions that, when executed by processing circuitry of a radio access network (RAN) node configured to receive channel state information (CSI) reports from a user equipment (UE) for a downlink (DL) channel to the UE, configure the RAN node to perform operations corresponding to any of the methods of embodiments B1-B5.
D4. A computer program product comprising computer-executable instructions that, when executed by processing circuitry of a radio access network (RAN) node configured to receive channel state information (CSI) reports from a user equipment (UE) for a downlink (DL) channel to the UE, configure the RAN node to perform operations corresponding to any of the methods of embodiments B1-B5.

1.-50. (canceled)

51. A method for a user equipment (UE) configured to provide channel state information (CSI) reports for a downlink (DL) channel, the method comprising:
receiving, from a radio access network (RAN) node, codebook subset restriction (CBSR) information that restricts reporting of vectors representative of the DL channel in a spatial-frequency domain, wherein the CBSR information includes an indication of one or more restricted entries of a codebook of vectors in the spatial-frequency domain;
determining a plurality of vectors and a corresponding plurality of scalar values representative of the DL channel in the spatial-frequency domain;
determining one or more of the following information based on the CBSR information:
a subset of the plurality of vectors;
a plurality of further vectors derived from the plurality of vectors; and
one or more measures of vector similarity between the plurality of vectors and the CBSR information; and
sending to the RAN node a CSI report including at least part of the determined information, wherein the included information is encoded using a machine learning (ML) model.

52. The method of claim 51, further comprising performing measurements of DL reference signals (RS) transmitted by the RAN node via the DL channel, wherein the plurality of vectors and the corresponding plurality of scalar values are determined based on the measurements.

53. The method of claim 51, wherein the CBSR information further includes one or more of the following:
a number of the vectors to be selected based on largest of the corresponding scalar values, and
an identifier of the ML model, which is capable of encoding the number of vectors.

54. The method of claim 51, wherein the indication of the one or more restricted entries of the codebook comprises a bitmap having a plurality of bits corresponding to respective vectors of the codebook, with a number of bits in the bitmap equal to a maximum allowed transmission rank.

55. The method of claim 51, wherein the CBSR information is received via radio resource control (RRC) message and the method further comprises:
sending to the RAN node a proposed modification to the CBSR information; and
receiving from the RAN node a lower layer message including modified CBSR information in accordance with the proposed modification,
wherein the information is determined based on the modified CBSR information.

56. The method of claim 51, wherein:
the method further comprising receiving from the RAN node a request for less restrictive CSI reporting; and
based on the request, the CSI report includes the plurality of vectors representative of the DL channel in the spatial-frequency domain, instead of the at least part of the determined information.

57. The method of claim 51, further comprising transmitting reference signals (RS) in an uplink (UL) channel to the RAN node, wherein the CBSR information is received responsive to transmitting the RS.

58. A method for a radio access network (RAN) node configured to receive channel state information (CSI) reports for a downlink (DL) channel, the method comprising:
sending, to a user equipment (UE), codebook subset restriction (CBSR) information that restricts reporting of vectors representative of the DL channel in a spatial-frequency domain, wherein the CBSR information includes an indication of one or more restricted entries of a codebook of vectors in the spatial-frequency domain;
receiving from the UE a CSI report including one of the following information that is based on the CBSR information and that is encoded based on a machine learning (ML) model:
a subset of a plurality of vectors that are representative of the DL channel in the spatial-frequency domain;
a plurality of further vectors derived from the plurality of vectors; or
one or more measures of vector similarity between the plurality of vectors and the CBSR information; and
decoding the encoded information using an ML model that corresponds to the ML model used to encode the information.

59. The method of claim 58, further comprising transmitting DL reference signals (RS) via the DL channel, wherein the CSI report is based on the DL RS.

60. The method of claim 58, wherein the CBSR information further includes one or more of the following:
a number of the vectors to be selected based on largest of the corresponding scalar values; and
an identifier of the ML model, which is capable of encoding the number of vectors.

61. The method of claim 58, wherein the CBSR information is sent via radio resource control (RRC) message and the method further comprises:
receiving from the UE a proposed modification to the CBSR information; and
sending to the UE a lower layer message including modified CBSR information in accordance with the proposed modification,
wherein the received encoded information is based on the modified CBSR information.

62. The method of claim 58, wherein:
the method further comprises sending to the UE a request for less restrictive CSI reporting; and
based on the request, the encoded information in the CSI report includes the plurality of vectors representative of the DL channel in the spatial-frequency domain, instead of the subset, the plurality of further vectors, or the one or more measures.

63. The method of claim 58, further comprising:
performing measurements of uplink (UL) reference signals (RS) transmitted by the UE;
based on the measurements, determining a plurality of vectors and a corresponding plurality of scalar values representative of the DL channel in the spatial-frequency domain; and
based on the corresponding scalar values, selecting one or more of the plurality of vectors that are associated with intercell interference,
wherein the CBSR is based on the selected one or more vectors.

64. User equipment (UE) configured to provide channel state information (CSI) reports for a downlink (DL) channel, the UE comprising:
communication interface circuitry configured to communicate with a radio access network (RAN) node; and
processing circuitry operatively coupled to the communication interface circuitry, wherein the processing circuitry and the communication interface circuitry are configured to:
receive, from the RAN node, codebook subset restriction (CBSR) information that restricts reporting of vectors representative of the DL channel in a spatial-frequency domain, wherein the CBSR information includes an indication of one or more restricted entries of a codebook of vectors in the spatial-frequency domain;
determine a plurality of vectors and a corresponding plurality of scalar values representative of the DL channel in the spatial-frequency domain;
determine one or more of the following information based on the CBSR information:
a subset of the plurality of vectors;
a plurality of further vectors derived from the plurality of vectors; and
one or more measures of vector similarity between the plurality of vectors and the CBSR information; and
send to the RAN node a CSI report including at least part of the determined information, wherein the included information is encoded using a machine learning (ML) model.

65. The UE of claim 64, wherein the CBSR information further includes one or more of the following:
a number of the vectors to be selected based on largest of the corresponding scalar values, and
an identifier of the ML model, which is capable of encoding the number of vectors.

66. The UE of claim 64, wherein the indication of the one or more restricted entries of the codebook comprises a bitmap having a plurality of bits corresponding to respective vectors of the codebook, with a number of bits in the bitmap equal to a maximum allowed transmission rank.

67. The UE of claim 64, wherein the CBSR information is received via radio resource control (RRC) message and the processing circuitry and the communication interface circuitry are further configured to:
send to the RAN node a proposed modification to the CBSR information; and
receive from the RAN node a lower layer message including modified CBSR information in accordance with the proposed modification,
wherein the information is determined based on the modified CBSR information.

68. Radio access network (RAN) node configured to receive channel state information (CSI) reports for a downlink (DL) channel, the RAN node comprising:
communication interface circuitry configured to communicate with a user equipment (UE); and
processing circuitry operatively coupled to the communication interface circuitry, wherein the processing circuitry and the communication interface circuitry are configured to:
send, to the UE, codebook subset restriction (CBSR) information that restricts reporting of vectors representative of the DL channel in a spatial-frequency domain, wherein the CBSR information includes an indication of one or more restricted entries of a codebook of vectors in the spatial-frequency domain;
receive from the UE a CSI report including one of the following information that is based on the CBSR information and that is encoded based on a machine learning (ML) model:
a subset of a plurality of vectors that are representative of the DL channel in the spatial-frequency domain;
a plurality of further vectors derived from the plurality of vectors; or
one or more measures of vector similarity between the plurality of vectors and the CBSR information; and
decode the encoded information using an ML model corresponding to the ML model used to encode the information.

69. The RAN node of claim 68, wherein the CBSR information further includes one or more of the following:
a number of the vectors to be selected based on largest of the corresponding scalar values; and
an identifier of the ML model, which is capable of encoding the number of vectors.

70. The RAN node of claim 68, wherein the CBSR information is sent via radio resource control (RRC) message and the processing circuitry and the communication interface circuitry are further configured to:
receive from the UE a proposed modification to the CBSR information; and
send to the UE a lower layer message including modified CBSR information in accordance with the proposed modification,
wherein the received encoded information is based on the modified CBSR information.

71. The RAN node of claim 68, wherein the processing circuitry and the communication interface circuitry are further configured to:
perform measurements of uplink (UL) reference signals (RS) transmitted by the UE;
based on the measurements, determine a plurality of vectors and a corresponding plurality of scalar values representative of the DL channel in the spatial-frequency domain; and
based on the corresponding scalar values, select one or more of the plurality of vectors that are associated with intercell interference,
wherein the CBSR is based on the selected one or more vectors.
